(19) United States
(12) Patent Application Publication
(10) Pub. No.: US 2019/0248515 A1
(43) Pub. Date: Aug. 15, 2019

(54) TRANSPORT METHOD, TRANSPORT SHIP, METHOD FOR MANUFACTURING TRANSPORT SHIP, LANDER, NAVIGATION METHOD, METHOD FOR MANUFACTURING COMPONENT OF LANDER, METHOD FOR MANUFACTURING LANDER, LANDING METHOD, MONITORING METHOD AND FUEL SUPPLY METHOD

(71) Applicant: ispace, inc., Tokyo (JP)

(72) Inventors: Takeshi HAKAMADA, Tokyo (JP); Takahiro NAKAMURA, Tokyo (JP); Toshiki TANAKA, Tokyo (JP); Daisuke FURUTOMO, Tokyo (JP); John WALKER, Tokyo (JP); Mohamed RAGAB, Tokyo (JP); Daishi MATSUKURA, Tokyo (JP); Abdelkader HAOUCHINE, Tokyo (JP); Damien HAIKAL, Tokyo (JP); Chit Hong YAM, Tokyo (JP); Julian Jakub GRAMATYKA, Tokyo (JP)

(21) Appl. No.: 16/324,539

(22) PCT Filed: Aug. 8, 2017
(86) PCT No.: PCT/JP2017/028681

§ 371 Date: Apr. 27, 2019

(30) Foreign Application Priority Data
Aug. 10, 2016 (JP) PCT/JP2016/073672

(51) Int. Cl. B64G 1/00; B64G 1/40

(52) U.S. Cl. CPC B64G 1/007; B64G 1/242; B64G 1/405

(57) ABSTRACT

A first step of propelling a transport ship from a low earth orbit or a geostationary transfer orbit to a targeted orbit or a destination with electric propulsion is provided.

### TECHNICAL FIELD

The present disclosure relates to a transport method, a transport ship, a method for manufacturing a transport ship, a lander, a method for manufacturing a component of a lander, a method for manufacturing a lander, a landing method, a monitoring method, and a fuel supply method.

### BACKGROUND ART

Usually, when spacecrafts such as a transport ship and the like are put into an orbit around the earth or an interplanetary orbit, each spacecraft is launched by a separate launcher (launch vehicle). On the other hand, a method for putting a plurality of spacecrafts escaping from an earth' s gravitational field into different orbits and launching each spacecraft toward different targets, in one-time launch has also been proposed (refer to JP 2006-188149 A).

An amount of fuel for transporting the transport ship from a low earth orbit (hereinafter, also referred to as LEO) to a lunar transition orbit (hereinafter, also referred to as LTO) by chemical propulsion requires about twice an amount of fuel for transporting the transport ship from a geostationary transfer orbit (hereinafter, referred to as GTO) to the LTO by the chemical propulsion. Therefore, the transport ship until now has been manufactured separately for a mission launched to the LEO and a mission launched to the GTO.

### SUMMARY OF INVENTION

A transport method according to an aspect of the present disclosure includes a first step of propelling a transport ship from a low earth orbit or a geostationary transfer orbit to a lunar transfer orbit by electric propulsion.

### BRIEF DESCRIPTION OF DRAWINGS

FIG. 1 is a schematic diagram showing a route of a transport ship according to a first embodiment.

FIG. 2 is a schematic diagram showing a configuration of the transport ship according to the first embodiment.

FIG. 3 is a schematic diagram showing a navigation process and a propulsion method of the transport ship according to the first embodiment.

FIG. 4 is a schematic diagram showing a route of a transport ship according to a second embodiment.

FIG. 5 is a schematic diagram showing a configuration of the transport ship according to the second embodiment.

FIG. 6 is a schematic diagram showing a navigation process and a propulsion method of the transport ship according to the second embodiment.

FIG. 7 is a schematic diagram showing a route of a transport ship according to a third embodiment.

FIG. 8 is a schematic diagram showing a configuration of the transport ship according to the third embodiment.

FIG. 9 is a schematic diagram showing a navigation process and a propulsion method of the transport ship according to the third embodiment.

FIG. 10 is a schematic diagram showing a lander according to a fourth embodiment.

FIG. 11 is a schematic diagram for describing a lander interface panel of the lander according to the fourth embodiment.

FIG. 12 is a block diagram showing a schematic configuration of a drawer according to the fourth embodiment.

FIG. 13 is a schematic diagram showing a change in inclination with respect to a horizontal surface of a solar panel of a lander when sunlight falls obliquely downward.

FIG. 14 is a schematic diagram showing a lander according to a modified example of the fourth embodiment.

FIG. 15 is a schematic diagram showing a use state of a heat insulating sheet according to a fifth embodiment.

FIG. 16 is a schematic diagram for describing a navigation method according to a sixth embodiment.

FIG. 17 is a schematic diagram for describing an example of a manufacturing method according to a seventh embodiment.

FIG. 18 is a schematic diagram for describing an example of a manufacturing method according to a modified example of the seventh embodiment.

FIG. 19 is a schematic diagram for describing an operation of a lander according to an eighth embodiment.

FIG. 20 is a schematic diagram showing a configuration of the lander according to a ninth embodiment.

FIG. 21 is a schematic diagram for describing a landing method according to a tenth embodiment.

FIG. 22 is a schematic diagram for describing a landing method according to an eleventh embodiment.

FIG. 23 is a schematic diagram for describing a monitoring method according to a twelfth embodiment.

FIG. 24A is a schematic diagram showing a lander that is not equipped with an engine and a thruster in a thirteenth embodiment.

FIG. 24B is a schematic diagram showing the lander that is equipped with the engine and the thruster in the thirteenth embodiment.

FIG. 25 is a schematic diagram showing a first half of steps of a fuel supply method according to a fourteenth embodiment.

FIG. 26 is a schematic diagram showing a second half of the steps of the fuel supply method according to the fourteenth embodiment.

FIG. 27 is a schematic diagram showing a configuration of the lander according to a fifteenth embodiment.

FIG. 28A is a schematic perspective view showing an example of a switching mechanism SW in a blocking state.

FIG. 28B is a schematic perspective view showing an example of the switching mechanism SW in an open state.

### DESCRIPTION OF EMBODIMENTS

In the future, it is planned that about half the number of launchers which can be mounted on transport ships equipped with space probes or the like will be launched to LEO and about the other half of the number of launchers will be launched to GTO. In order to increase a frequency of transportation cargo such as satellites and space probes to destinations such as the moon, asteroids, and other planets, it is necessary to mount and launch a transport ship on a launcher for both missions. In this case, in the related art, since it is necessary to manufacture a transport ship by a separate design for each mission, there is a problem that the manufacturing cost of the transport ship is increased.

The present disclosure has been made in view of the above problems, and an object of the present disclosure is to provide a transport method, a transport ship, and a method for manufacturing a transport ship, which can reduce manufacturing cost of the transport ship.

A transport method according to a first aspect of the present disclosure includes a first step of propelling a transport ship from a low earth orbit or a geostationary transfer orbit to a lunar transfer orbit by electric propulsion.

According to this configuration, since the transport ship moves from either the low earth orbit or the geostationary transfer orbit to a targeted orbit or a destination by the electric propulsion, the transport ship can be commonly designed regardless of orbits of launch destinations of the launchers on which the transport ships are mounted. Thereby, the manufacturing cost of the transport ship can be reduced by mass production. In addition, since fuel for chemical propulsion is not used from the low earth orbit or the geostationary transfer orbit to the targeted orbit or the destination, the amount of propellant for chemical propulsion can be reduced, so a weight of the transport ship can be reduced and the launch cost can be reduced.

In the transport method according to a second aspect of the present disclosure as described in the transport method according to the first aspect, the electric propulsion is made by using power generated by a solar cell.

According to this configuration, the transport ship can be propelled using the power generated by the solar cell.

The transport method according to a third aspect of the present disclosure as described in the transport method according to the first or second aspect, the first step includes a step of expanding a solar panel on which a solar cell is mounted.

According to this configuration, since a larger amount of power can be generated, it is possible to shorten the time taken for the transport ship to arrive from the earth low orbit or the geostationary transfer orbit to the targeted orbit or the destination.

The transport method according to a fourth aspect of the present disclosure as described in any one of the first to third aspects includes, after the first step, a second step of propelling the transport ship by chemical propulsion.

According to this configuration, it is possible to accelerate the transport ship and transport the transport ship to a next targeted orbit or destination in a short time.

The transport method according to a fifth aspect of the present disclosure as described in the transport method according to the fourth aspect includes a step of separating a module having an electric propulsion device from the transport ship between the first step and the second step.

According to this configuration, since the weight of the transport ship can be reduced by separating the module having the unnecessary electric propulsion device, so it is possible to reduce a loading amount of fuel for the chemical propulsion.

The transport method according to a sixth aspect of the present disclosure as described in the transport method according to the fifth aspect includes, after the separating step and before the second step, a step of controlling an attitude of the transport ship so that a direction in which a chemical propulsion device ejects a gas is directed in a direction opposite to a traveling direction of the transport ship.

According to this configuration, since the gas is ejected in the direction opposite to the traveling direction, the transport ship can travel in the traveling direction.

The transport method according to a seventh aspect of the present disclosure as described in the transport method according to any one of the fourth to sixth aspects includes a step of propelling the transport ship from a lunar transfer orbit to a low lunar orbit, separating a module having a tank for the chemical propulsion after the propulsion to the low lunar orbit, and landing the transport ship on a lunar surface after the separation in the second step.

According to this configuration, the transport ship can transport a transport object such as the mounted space probe to the lunar surface.

The transport method according to an eighth aspect of the present disclosure as described in the transport method according to any one of the fourth to sixth aspects includes a step of propelling the transport ship from the lunar transfer orbit to the low lunar orbit and separating cargo after the propulsion to the low lunar orbit in the second step.

According to this configuration, it is possible to transport the cargo to the low lunar orbit.

A transport ship according to a ninth aspect of the present disclosure includes an electric propulsion device which propels a transport ship from a low earth orbit or a geostationary transfer orbit to a targeted orbit or a destination by electric propulsion.

According to this configuration, since the transport ship moves from either the low earth orbit or the geostationary transfer orbit to a targeted orbit or a destination by the electric propulsion, the transport ship can be commonly designed regardless of orbits of launch destinations of the launchers on which the transport ships are mounted. As a result, the manufacturing cost of the transport ship can be reduced by mass production. In addition, since fuel for chemical propulsion is not used from the low earth orbit or the geostationary transfer orbit to a targeted orbits or a destination, the amount of propellant for chemical propulsion can be reduced, so a weight of the transport ship can be reduced and the launch cost can be reduced.

The transport ship according to a tenth aspect of the present disclosure as described in the transport method according to the ninth aspect includes: a tank in which a propellant of the electric propulsion device is stored; and a control unit controlling opening and closing of a valve of the tank.

According to this configuration, it is possible to adjust the amount of supply of the propellant to the electric propulsion device.

The transport ship according to an eleventh aspect of the present disclosure as described in the transport ship according to the tenth aspect includes a first module which has the electric propulsion device and the tank; a second module which has a chemical propulsion device, a landing gear, and the control unit; and a third module which has a tank in which fuel for the chemical propulsion device is stored, in which the control unit controls the opening and closing of the valve of the tank of the first module.

According to this configuration, after the transport ship is propelled from the low earth orbit (LEO) or the geostationary transfer orbit (GEO) to a lunar transition orbit (LTO) by the electric propulsion, the first module is separated, and after the transport ship is propelled from the lunar transition orbit (LTO) to a low lunar orbit (also referred to as LLO) by the chemical propulsion, the third module is separated and the second module can land on the moon.

The transport ship according to a twelfth aspect of the present disclosure as described in the transport ship according to the tenth aspect includes: a first module which has the electric propulsion device and the tank; and a fourth module which has a chemical propulsion device and the control unit, in which the control unit controls the opening and closing of the valve of the tank of the first module.

According to this configuration, after the transport ship is propelled from the low earth orbit (LEO) or the geostationary transfer orbit (GEO) to the lunar transition orbit (LTO) by the electric propulsion, the first module is separated, the transport ship can be propelled from the lunar transition orbit (LTO) to the low lunar orbit (LLO) by the chemical propulsion, and the cargo can be transported to the low lunar orbit (LLO).

In the transport ship according to a thirteenth aspect of the present disclosure as described in the transport ship according to the tenth aspect, the electric propulsion device, the tank, and the control unit are mounted in one module.

According to this configuration, since the modules can be mass-produced, the manufacturing cost of the transport ship can be suppressed and the manufacturing speed of the transport ship can be increased.

A method for manufacturing a transport ship according to a fourteenth aspect of the present disclosure includes any of a step of manufacturing the transport ship using a first module, a second module, and a third module, a step of manufacturing the transport ship using the first module and a fourth module, and a step of manufacturing the transport ship using a fifth module, in which the first module has an electric propulsion device and a tank in which a propellant of the electric propulsion device is stored, the second module has a chemical propulsion device, a landing gear, and a control unit which controls opening and closing of a valve of the tank of the first module, the third module has a tank in which fuel for the chemical propulsion device is stored, the fourth module has the chemical propulsion device and the control unit which controls the opening and closing of the valve of the tank of the first module, and the fifth module has the electric propulsion device, the tank in which the propellant of the electric propulsion device is stored, and the control unit which controls the opening and closing of the valve of the tank.

According to this configuration, it is possible to reduce the manufacturing cost of the transport ship and increase the manufacturing speed of the transport ship by mass-producing the first to fifth modules. In addition, the transport ship manufactured using the first module, the second module, and the third module can land on the moon, asteroids, and the like as in the first embodiment. In addition, the transport ship manufactured using the first module and the fourth module can transport cargo to a targeted orbit. In addition, the transport ship manufactured using a fifth module 50 can transport the cargo to a destination in deep space as in the third embodiment. Therefore, according to the manufacturing method, it is possible to manufacture the transport ship which can move to any point in space.

A lander according to a fifteenth aspect of the present disclosure includes a lander interface panel which connects between the lander and a drawer interface panel of a drawer in which a payload is mounted, in which the lander interface panel includes a voltage output terminal connected to the drawer interface panel to supply a voltage to the payload via the drawer interface panel, and a signal terminal connected to the drawer interface panel to exchange a signal with a controller mounted on the drawer via the drawer interface panel.

According to this configuration, a voltage can be supplied from the lander to the payload, and the lander can communicate with the payload via the controller.

A lander according to a sixteenth aspect of the present disclosure includes a solar panel, a drive mechanism which changes an inclination of the solar panel with respect to a horizontal plane, and a controller which controls the drive mechanism to change the inclination of the solar panel with respect to the horizontal plane according to time, a position of the sun, or a power generation amount of the solar panel.

According to this configuration, the controller can change the inclination of the solar panel with respect to the horizontal plane according to the position of the sun and increase the amount of light hitting the solar panel, thereby increasing the power generation amount of the solar panel.

A lander according to a seventeenth aspect of the present disclosure includes a heat insulating sheet which is folded and stored and can be self-supported when being unfolded from the folded state, in which the heat insulating sheet is configured to cover an outside of the lander when being unfolded.

According to this configuration, the heat insulating sheet reflects sunlight and has heat insulating property, so a change in temperature of the lander can be reduced.

A lander according to an eighteenth aspect of the present disclosure includes a housing made of graphene or a graphene fiber as a material.

According to this configuration, it is possible to improve the heat insulating property of the housing.

In a navigation method according to a nineteenth aspect of the present disclosure, a navigation method of a spacecraft from a geostationary transfer orbit to a celestial body other than the earth or an orbit of the celestial body is made common regardless of an orbit of a first launch destination.

According to this configuration, it is possible to navigate the spacecraft to the targeted celestial body regardless of the orbit of the first launch destination.

A method for manufacturing a component of a lander according to a twentieth aspect of the present disclosure includes a step of manufacturing the component of the lander by a 3D printer disposed on a celestial body other than the earth.

According to this configuration, when the component of the lander is broken or damaged, the component of the lander can be manufactured by a 3D printer on a celestial body other than the earth and the manufactured component can replace the broken component.

The method for manufacturing a component of a lander according to a twenty-first aspect of the present disclosure as described in the manufacturing method according to the twentieth aspect includes a step of melting a broken or damaged component of the lander, and manufacturing a component of a spacecraft by the 3D printer using the melted material as a raw material in the manufacturing step.

According to this configuration, when the component of the lander is broken or damaged, the component of the lander can be reused to manufacture the component of the spacecraft.

The method for manufacturing a component of a lander according to a twenty-second aspect of the present disclosure as described in the manufacturing method according to the twentieth aspect includes a step of extracting a natural resource on the celestial body other than the earth, and manufacturing the component of the lander by the 3D printer using the extracted natural resource as the raw material in the manufacturing step.

According to this configuration, it is possible to manufacture the component of the lander more inexpensively.

A method for manufacturing a lander according to a twenty-third aspect of the present disclosure is a method for manufacturing a lander on a celestial body other than the earth, and includes a step of extracting a natural resource on a celestial body other than the earth or melting a broken or damaged component of the lander, a step of manufacturing a component of the lander by a 3D printer using the extracted natural resource or the melted material as a raw material, and a step of attaching the manufactured component of the lander to a targeted lander.

According to this configuration, since the component of the lander is manufactured using as a raw material the natural resource extracted from the celestial bodies (for example, a planet, a secondary planet, an asteroid, or a comet) other than the earth, it is possible to manufacture the lander more inexpensively. Alternatively, even if the component of the lander is broken or damaged, the lander can be regenerated.

A lander according to a twenty-fourth aspect of the present disclosure includes a movable leg or a wheel so as to be movable on a celestial body other than the earth.

According to this configuration, the lander can move on the celestial bodies (for example, a planet, a secondary planet, an asteroid, or a comet) other than the earth.

A lander according to a twenty-fifth aspect of the present disclosure includes a reflector which reflects light, in which a direction of the reflector is set so that a solar panel of an object is irradiated with sunlight reflected from the reflector.

According to this configuration, since the object can be irradiated with the reflected light, a power generation amount in the solar panel of the object can be increased.

A landing method according to a twenty-sixth aspect of the present disclosure is a method for landing a lander on a targeted celestial body other than the earth, and includes a step of wirelessly transmitting a response request to any spacecraft existing on the targeted celestial body other than the earth, a step of receiving a response signal including a position of a self-controlled spacecraft which is transmitted in response to the response request, and a step of landing the lander while avoiding a position included in the response signal.

According to this configuration, the lander can land while avoiding any spacecraft existing on the celestial bodies (for example, planets, secondary planets, asteroids, comets or the like) other than the earth.

A landing method according to a twenty-seventh aspect of the present disclosure is a method for landing a lander on a celestial body other than the earth, and includes a step of acquiring map data of a celestial body scheduled to land from an artificial satellite by wireless communication, a step of determining whether or not a zone scheduled to land is an unstable zone by using the map data, and a step of igniting a thruster of the lander to land the lander on different zones if it is determined that the landing zone is the unstable zone.

According to this configuration, the lander can land while avoiding the unstable zone.

In a monitoring method according to a twenty-eighth aspect of the present disclosure, a spacecraft launched from the earth is monitored by a monitoring spacecraft disposed at a Lagrange point and a plurality of artificial satellites disposed on a orbit around a celestial body other than the earth.

According to this configuration, it is possible to observe the navigation of the spacecraft.

A lander according to a twenty-ninth aspect of the present disclosure includes a first interface which freely attaches and removes a propulsion system, in which the propulsion system having a second interface suitable for the first interface can be replaced on a celestial body other than the earth, and a standard of the first interface and the second interface is set.

According to this configuration, it is possible to easily replace the propulsion system by standardizing the first interface and the second interface.

A fuel supply method according to a thirtieth aspect of the present disclosure is a fuel supply method for allowing a transport ship in flight to supply fuel to another spacecraft, and includes a step of removing a first fuel tank from the spacecraft, a step of removing a second fuel tank loaded on the transport ship, and a step of connecting the removed second fuel tank to the spacecraft.

According to this configuration, since the first fuel tank of the spacecraft can be replaced with the second fuel tank, it is possible to supply fuel to the spacecraft.

A lander according to a thirty-first aspect of the present disclosure includes: a housing; a switching mechanism which switches between an open state in which heat in the housing is discharged and a blocking state in which the heat in the housing is blocked; a temperature sensor which measures temperature inside or outside the housing; and a processor which controls the switching mechanism to switch between the open state and the blocking state according to the temperature measured by the temperature sensor.

According to this configuration, when the temperature outside the housing rises, the switching to the blocking state is performed to suppress an inflow of heat into the housing, and when the temperature outside the housing is decreased, the switching to the open state is performed to discharge the heat into the housing, so it is possible to suppress the change in the temperature inside the housing.

Increasing the launch frequency of the transport ship gives rise to another problem of increasing the manufacturing speed of the transport ship. On the other hand, in each embodiment, the transport ship is configured by combining one to three modules among the first to fifth modules. As a result, the first to fifth modules can be mass-produced to increase the manufacturing speed of the transport ship. Hereinafter, each embodiment will be described with reference to the accompanying drawings.

In each embodiment, as an example, the transport ship or the lander will be described as landing on the moon. It is to be noted that the transport ship or the lander is not limited to these embodiments, but may land on other secondary planets, planets, asteroids, comets, or the like.

### First Embodiment

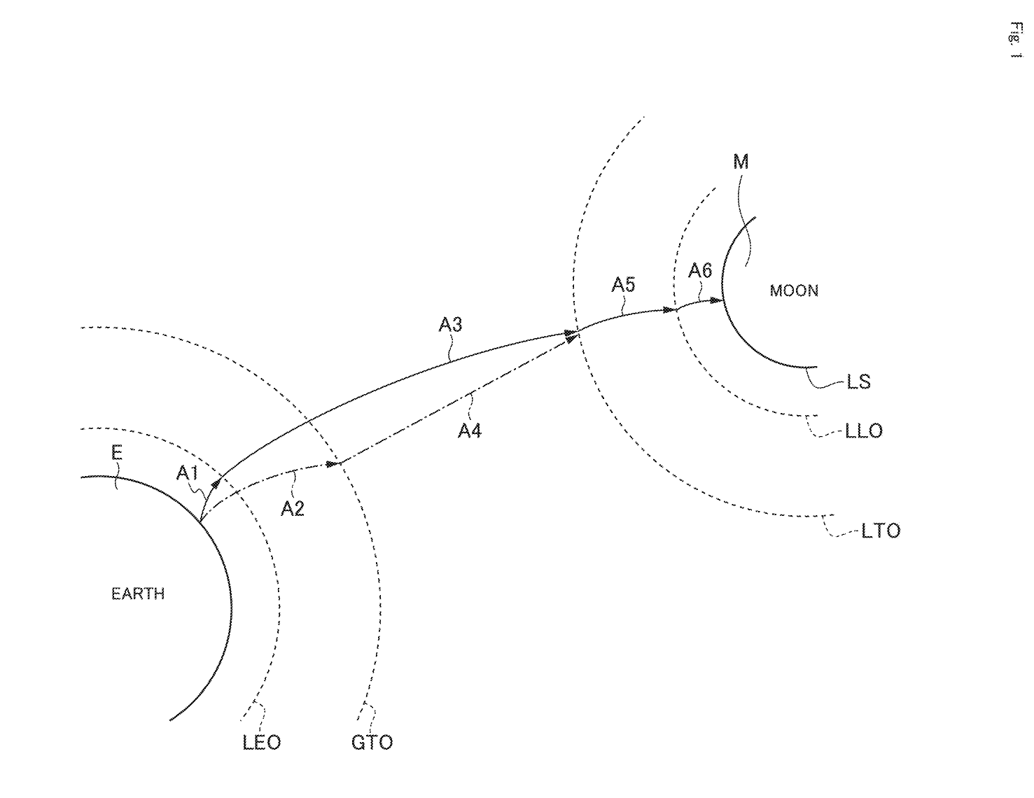

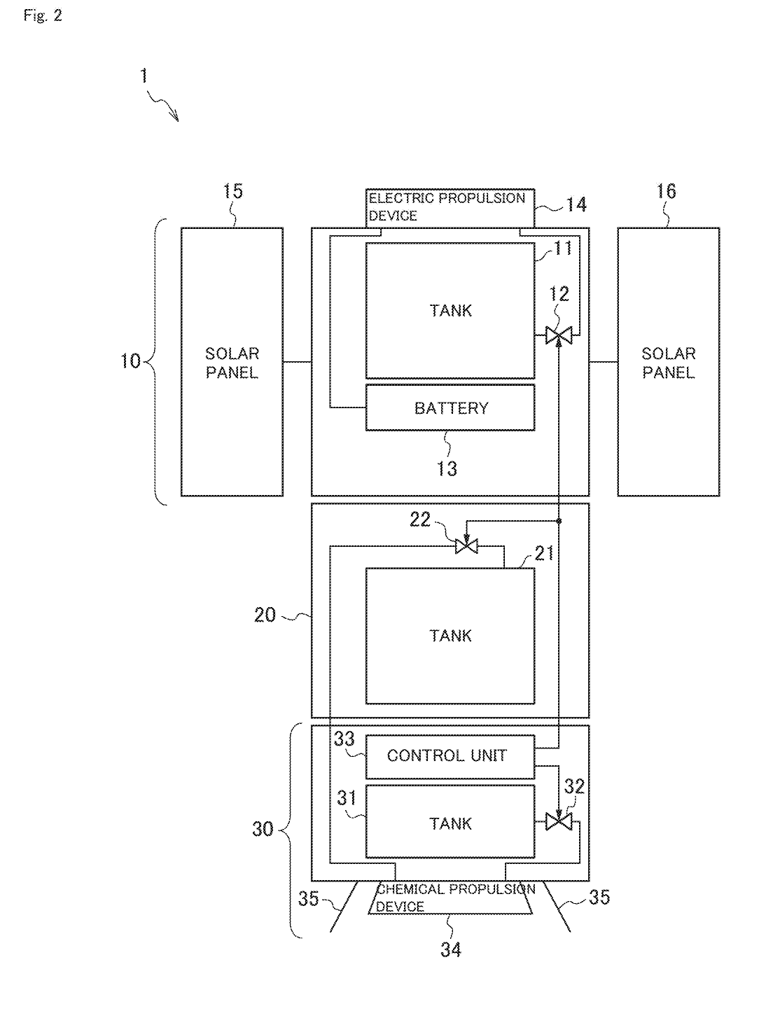

First, a first embodiment will be described. FIG. 1 is a schematic diagram showing a route of a transport ship according to the first embodiment. A transport ship 1 according to the first embodiment is a transport ship transporting cargo in outer space, and transports a space probe from the earth E to the moon M. FIG. 2 is a schematic diagram showing a configuration of the transport ship according to the first embodiment. The transport ship 1 includes a first module 10, a second module 30, and a third module 20. The second module 30 is a lander which lands on a lunar surface and has the probe inside held therein. Here, the lander is a spacecraft which can land and stop on a surface of a celestial body (for example, secondary planets such as the moon, asteroids, planets, or the like).

The first module 10 includes a tank 11, a valve 12 provided on the tank 11, a battery 13, an electric propulsion device 14, and solar panels 15 and 16.

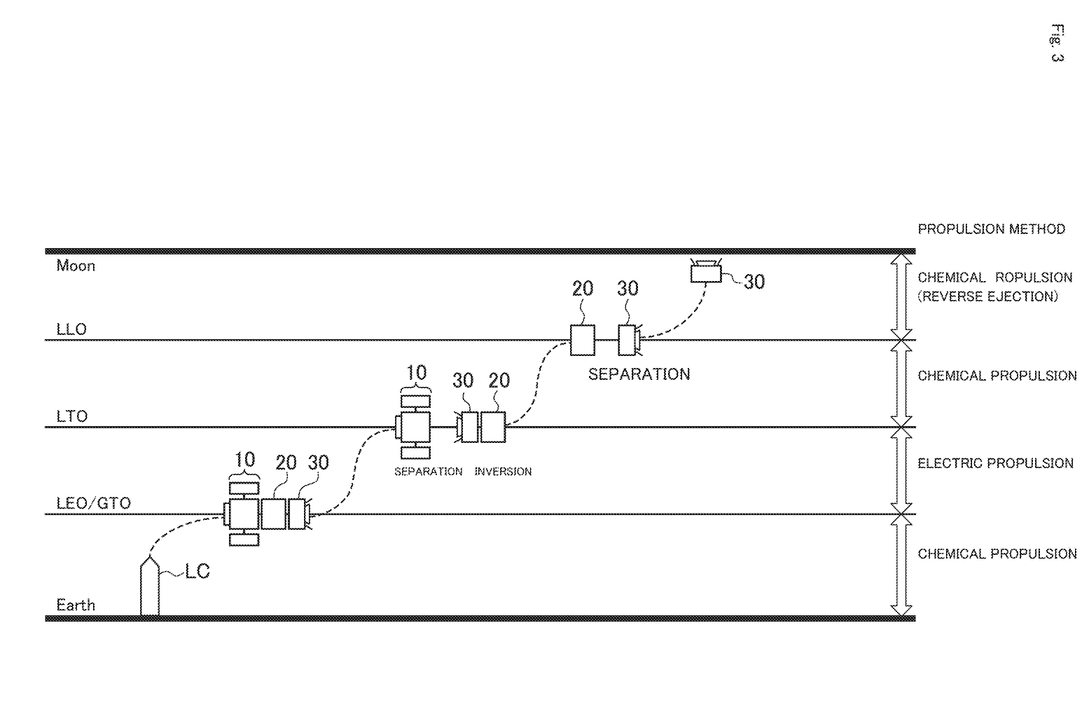

The tank 11 stores a propellant for electric propulsion. The tank 11 is constituted by, for example, a plurality of detachable cassettes. As a result, the number of cassettes can be changed depending on whether or not an orbit at which the transport ship 1 is launched by a launcher LC (see FIG. 3) is LEO or GTO. For example, when the transport ship 1 is launched to the LEO by the launcher LC, a distance for electric propulsion is longer than the GTO, so a larger number of cassettes can be loaded than when the transport ship 1 is launched to the LEO.

The valve 12 whose one end communicates with the tank 11 and the other end communicates with the electric propulsion device 14 can be opened and closed. The propellant stored in the tank 11 is supplied to the electric propulsion device 14 by opening the valve 12. The opening and closing of the valve 12 are controlled by a control unit 33 to be described later.

The battery 13 stores power generated by the solar panels 15 and 16.

The solar panels 15 and 16 are mounted with solar cells and generate electricity using sunlight. The solar panels 15 and 16 are controlled to be unfolded by the control unit 33 to be described later.

The electric propulsion device 14 propels the transport ship using power generated by the solar cells. In the first embodiment, the electric propulsion device 14 is a hall thruster as an example. Here, the hall thruster is an electric propulsion device which mainly operates an electric field gradient in an axial direction in which an external cathode is applied to ions, but promotes ionization of a propellant by applying to electrons a magnetic field enough to obtain a confinement effect generated by a hall effect.

The electric propulsion device 14 may be an ion engine instead of the hall thruster. The ion engine is an electrostatic acceleration type propulsion device which heats and ionizes the propellant by using arc discharge, microwave, or the like to generate plasma, and applies a high voltage to a plurality of porous electrodes to accelerate ions.

The third module 20 includes a tank 21 and a valve 22 provided on the tank 21.

The tank 21 stores a propellant for chemical propulsion. The tank 21 has, for example, a tank for fuel and a tank for an oxidant.

The valve 22 whose one end communicates with the tank 21 and the other end communicates with a chemical propulsion device 34 can be opened and closed. The propellant stored in the tank 21 is supplied to the chemical propulsion device 34 by opening the valve 22. The opening and closing of the valve 22 are controlled by a control unit 33 to be described later.

The second module 30 includes a tank 31, a valve 32 provided on the tank 31, a control unit 33, a chemical propulsion device 34, and a landing gear 35. In addition, the second module 30 mounts a transport object such as a space probe.

The tank 31 stores a propellant for chemical propulsion. The tank 31 has, for example, a tank for fuel and a tank for an oxidant.

The valve 32 whose one end communicates with the tank 31 and the other end communicates with a chemical propulsion device 34 can be opened and closed. The propellant stored in the tank 31 is supplied to the chemical propulsion device 34 by opening the valve 32. The opening and closing of the valve 32 are controlled by the control unit 33.

The control unit 33 controls the opening and closing of the valve 12, the valve 22, and the valve 32. In addition, the control unit 33 controls a separation of the first module 10 from the transport ship 1. In addition, the control unit 33 controls a separation of the third module 20 from the transport ship 1. In addition, the control unit 33 controls the chemical propulsion device 34. For example, the control unit 33 includes a sensor (for example, a gyro sensor) for attitude detection, and controls an attitude of the transport ship 1 using the chemical propulsion device 34. The control unit 33 has a landing guide and navigation controller (GNC) for landing control.

The chemical propulsion device 34 is controlled by the control unit 33 to burn fuel supplied from the tank 21 or the tank 31 and eject a gas. The chemical propulsion device 34 according to the first embodiment is a thruster as an example.

The landing gear 35 supports the second module 30 at the time of landing on a lunar surface.

Subsequently, a route of a transport ship and a propulsion method for each section in the route will be described with reference to FIGS. 1 and 3 . FIG. 3 is a schematic diagram showing a navigation process and a propulsion method of the transport ship according to the first embodiment. As shown in FIG. 3, the transport ship 1 is mounted on the launcher LC and launched from the earth E. The transport ship is launched to LEO as shown by arrow A1 in FIG. 1 or launched to the GTO as shown by arrow A2 in FIG. 1. As shown in FIG. 3, in the LEO or the GTO, the transport ship 1 is separated from the launcher LC. Thereafter, in the transport ship 1, the solar panels 15 and 16 on which the solar cells are mounted are unfolded. As a result, since a larger amount of power can be generated, the time taken for the transport ship to reach from the LEO or the GTO to the LTO can be shortened. The transport ship 1 is propelled using power generated by the solar cells. As a result, the transport ship 1 moves from the LEO to the LTO as shown by arrow A3 in FIG. 1 or moves from the GTO to the LTO as shown by arrow A4 in FIG. 1.

As described above, since the transport ship 1 moves from any of the LEO or the GTO to the LTO by the electric propulsion, the design of the transport ship can be common regardless of the orbit of the launch destination of the launcher LC on which the transport ship 1 is mounted. As a result, the manufacturing cost of the transport ship can be reduced by mass production.

Thereafter, as shown in FIG. 3, the first module 10 is separated from the transport ship 1 in the LTO, and the transport ship 1 after the separation is configured to include only the third module 20 and the second module 30. Then, the control unit 33 of the second module 30 controls the attitude of the transport ship 1 using the chemical propulsion device 34 so that a direction in which the chemical propulsion device 34 ejects a gas is directed in a direction opposite to a traveling direction of the transport ship. As a result, the attitude of the transport ship 1 is substantially reversed. After the substantial reverse, the control unit 33 controls the chemical propulsion device 34 to eject a gas. As a result, a gas in a reverse direction to the traveling direction is ejected, and the transport ship 1 proceeds in the traveling direction. Then, as shown by arrow A5 in FIG. 1, the transport ship 1 moves to a low lunar orbit (also referred to as LLO) while accelerating.

Next, as shown in FIG. 3, the second module 30 is separated from the transport ship 1 in the LLO, and the transport ship 1 after the separation is configured to include only the second module 30. Then, the control unit 33 of the second module 30 controls the attitude of the transport ship 1 using the chemical propulsion device 34 so that a gas can be ejected in the traveling direction. After the attitude control, the control unit 33 controls the chemical propulsion device 34 to eject a gas. As a result, a gas is ejected in the traveling direction, and the transport ship 1 decelerates. Ejecting a gas in the traveling direction in this manner is referred to as reverse ejection. As a result, as shown in arrow A6 of FIG. 1 and FIG. 3, the transport ship 1 lands on a lunar surface LS while decelerating.

As described above, a transport method according to the first embodiment includes a first step of propelling a transport ship 1 from LEO or GTO to LTO by electric propulsion.

As a result, since the transport ship 1 moves from any of the LEO or the GTO to the LTO by the electric propulsion, the design of the transport ship can be common regardless of the orbit of the launch destination of the launcher LC. Thereby, the manufacturing cost of the transport ship can be reduced by mass production. In addition, since fuel for chemical propulsion is not used from the LEO or the GTO to the LTO, the amount of propellant for chemical propulsion can be reduced, so a weight of the transport ship can be reduced and the launch cost can be reduced.

In addition, the transport method according to the first embodiment includes a second step of propelling the transport ship 1 after the separation from the LTO to the lunar surface LS by the chemical propulsion. As a result, the transport ship 1 can be propelled to the lunar surface LS.

In this second step, the transport ship is propelled to the LLO while accelerating. In the second step, the transport method includes a step of separating the transport ship 1 after being propelled to the LLO and landing the transport ship 1 after the separation on the lunar surface while decelerating. As a result, the transport ship 1 can transport the transport object such as a space probe to the lunar surface.

In addition, the transport ship 1 according to the first embodiment includes the first module 10 including the electric propulsion device 14 and the tank 11 in which the propellant of the electric propulsion device 14 is stored, the second module 30 including the chemical propulsion device 34, the landing gear 35, and the control unit 33 which controls the opening and closing of the valve of the tank 11, and the third module 20 including the tank 21 in which the fuel of the chemical propulsion device 34 is stored.

As a result, after the transport ship 1 is propelled from the LEO or the GEO to the LTO by the electric propulsion, the first module 10 is separated, and after the transport ship 1 is propelled from the LTO to the LLO by the chemical propulsion, the third module 20 is separated and the second module 30 can land on the moon.

In the first embodiment, the transport ship 1 lands on the moon, but may land on asteroids, planets, or other secondary planets.

### Second Embodiment

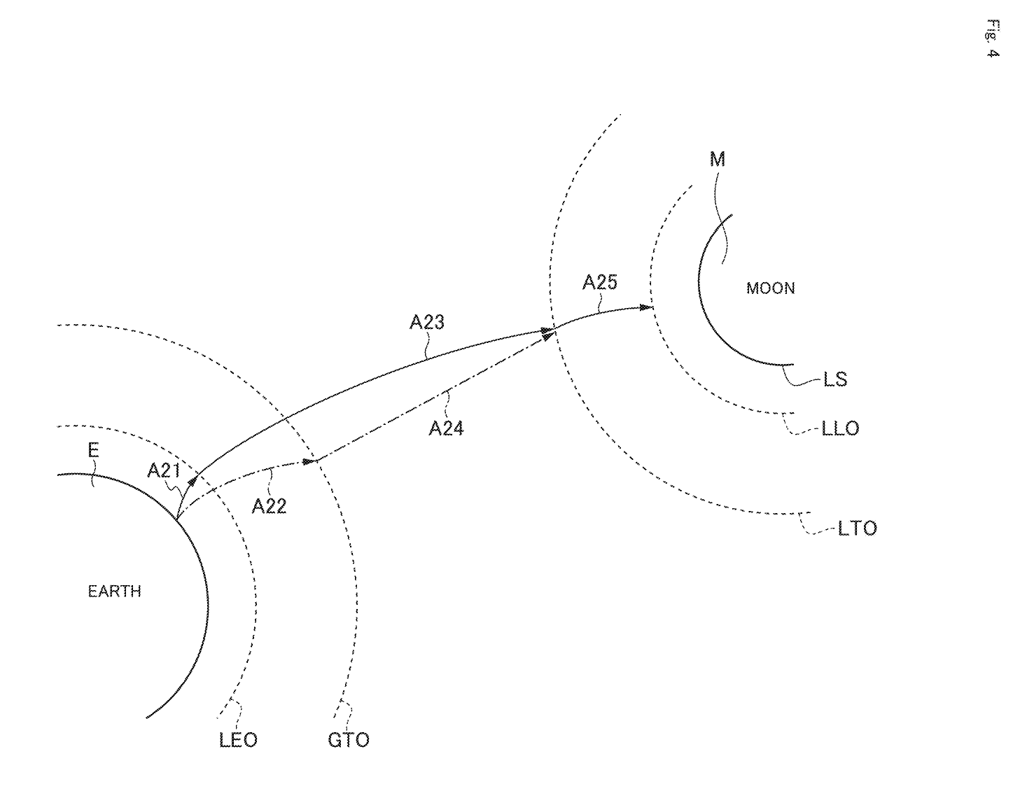

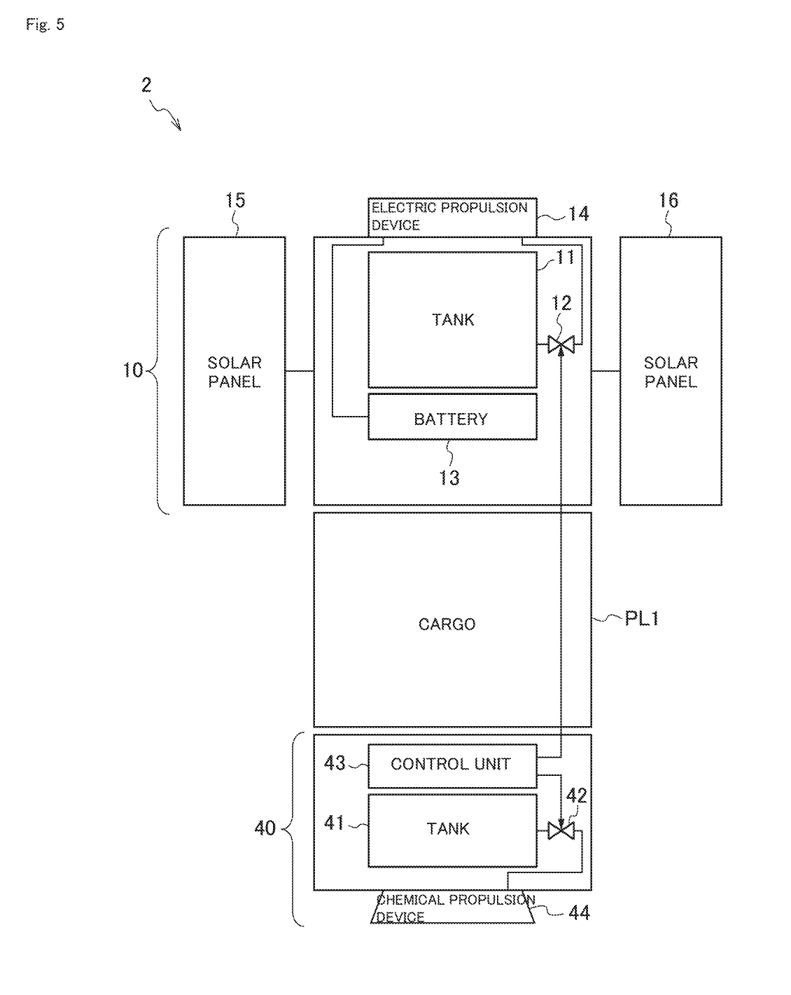

Next, a second embodiment will be described. FIG. 4 is a schematic diagram showing a route of a transport ship according to the second embodiment . A transport ship 2 according to the second embodiment is a transport ship transporting cargo in outer space, and transports cargo from the earth E to LLO. FIG. 5 is a schematic diagram showing a configuration of the transport ship according to the second embodiment. The transport ship 2 includes a first module 10, cargo PL1, and a fourth module 40. The first module 10 is common to the first module 10 according to the first embodiment, and thus a description thereof is omitted. The cargo PL1 according to the second embodiment is a satellite, for example.

The fourth module 40 includes a tank 41, a valve 42 provided on the tank 41, a control unit 43, and a chemical propulsion device 44. The fourth module 40 is configured so that a landing gear 35 and a landing GNC are omitted from the second module 30.

The tank 41 stores a propellant for chemical propulsion. The tank 41 has, for example, a tank for fuel and a tank for an oxidant.

The valve 42 whose one end communicates with the tank 41 and the other end communicates with the chemical propulsion device 44 can be opened and closed. The propellant stored in the tank 41 is supplied to the chemical propulsion device 44 by opening the valve 42. The opening and closing of the valve 42 are controlled by the control unit 43.

The control unit 43 controls opening and closing of the valve 12 and the valve 42. In addition, the control unit 43 controls a separation of the first module 10 from the transport ship 2. In addition, the control unit 43 controls a separation of the cargo PL1 from the transport ship 2. In addition, the control unit 43 controls the chemical propulsion device 44. For example, the control unit 43 includes a sensor (for example, a gyro sensor) for attitude detection, and controls an attitude of the transport ship 2 using the chemical propulsion device 44.

The chemical propulsion device 44 is controlled by the control unit 43 to burn fuel supplied from the tank 41 and eject a gas . The chemical propulsion device 44 according to the second embodiment is a thruster as an example.

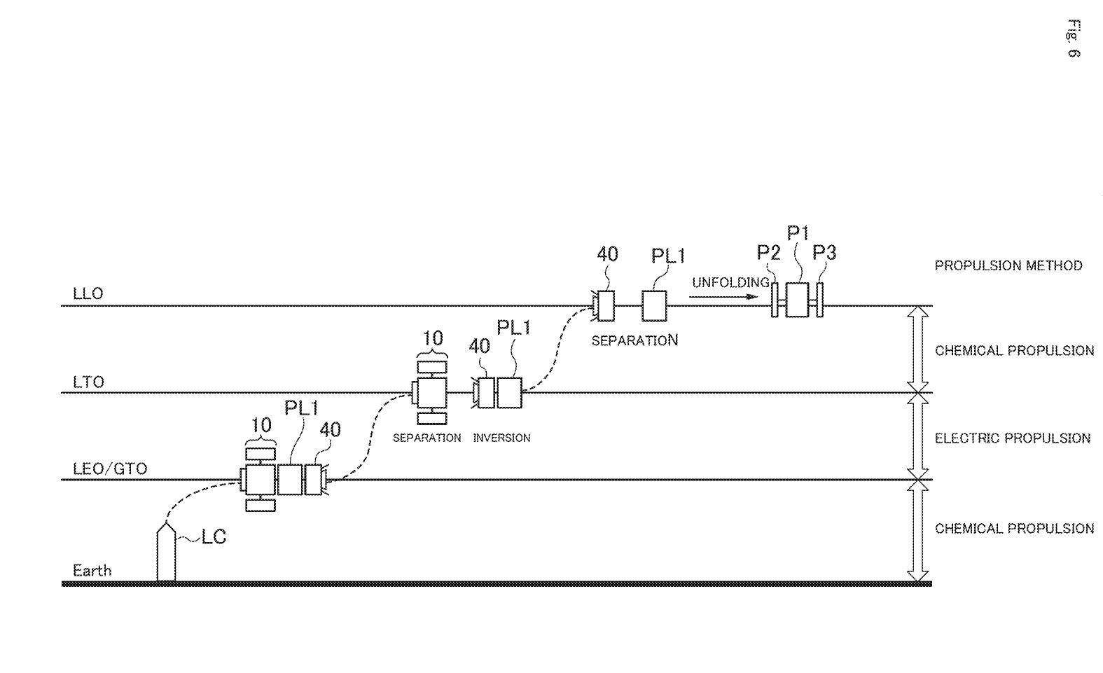

Subsequently, a route of a transport ship and a propulsion method for each section in the route will be described with reference to FIGS. 4 and 6. FIG. 6 is a schematic diagram showing a navigation process and a propulsion method of the transport ship according to the second embodiment. As shown in FIG. 6, the transport ship 2 is mounted on a launcher LC and launched from the earth E. The transport ship is launched to LEO as shown by arrow A21 in FIG. 4 or launched to GTO as shown by arrow A22 in FIG. 4. As shown in FIG. 6, in the LEO or the GTO, the transport ship 2 is separated from the launcher LC. Thereafter, in the transport ship 2, a solar panel 211 on which solar cells are mounted are unfolded. The transport ship 2 is propelled using power generated by a solar cell. As a result, the transport ship 2 moves from the LEO to the LTO as shown by arrow A23 in FIG. 4 or moves from the GTO to the LTO as shown by arrow A24 in FIG. 4.

As described above, since the transport ship 2 moves from any of the LEO or the GTO to the LTO by the electric propulsion, the design of the transport ship can be common regardless of the orbit of the launch destination of the launcher LC on which the transport ship 2 is mounted. Thereby, the manufacturing cost of the transport ship can be reduced by mass production.

Next, as shown in FIG. 6, the first module 10 is separated from the transport ship 2 in the LTO, and the transport ship 2 after the separation is configured to include only the cargo PL1 and the fourth module 40. Then, the control unit 43 of the fourth module 40 controls the attitude of the transport ship 2 using the chemical propulsion device 44 so that a direction in which the chemical propulsion device 44 ejects a gas is directed in a direction opposite to a traveling direction of the transport ship. As a result, the direction of the transport ship 2 is substantially reversed. After the substantial reverse, the control unit 43 controls the chemical propulsion device 44 to eject a gas. As a result, a gas is ejected in a reverse direction to the traveling direction, and the transport ship 2 proceeds in the traveling direction. Then, as shown by arrow A25 in FIG. 4, the transport ship 2 moves to the LLO while accelerating.

Next, as shown in FIG. 6, the cargo PL1 is separated from the transport ship 2 on the LLO. Then, the cargo PL1 unfolds folded panels P1 to P3 as shown in FIG. 6. As a result, the cargo PL1 can observe the moon as an artificial satellite on the LLO.

As described above, a transport method according to the second embodiment includes a first step of propelling a transport ship 2 from LEO or GTO to LTO by electric propulsion and a second step of propelling the transport ship 2 from the LTO to LLO by chemical propulsion.

As a result, since the transport ship 2 moves from any of the LEO or the GTO to the LTO by the electric propulsion, the design of the transport ship can be common regardless of the orbit of the launch destination of the launcher LC. Thereby, the manufacturing cost of the transport ship can be reduced by mass production. In addition, since fuel for chemical propulsion is not used from the LEO or the GTO to the LTO, the amount of propellant for chemical propulsion can be reduced, so a weight of the transport ship can be reduced and the launch cost can be reduced.

The transport ship 2 according to the second embodiment includes the first module 10 including an electric propulsion device 14 and a tank 11 in which a propellant of the electric propulsion device is stored, and the fourth module 40 including a chemical propulsion device 44 and a control unit 43 which controls the opening and closing of the valve of the tank 11.

As a result, after the transport ship 2 is propelled from the LEO or the GEO to the LTO by the electric propulsion, the first module 10 can be separated, and the transport ship 2 can be propelled from the LTO to the LLO by the chemical propulsion and can transport the cargo PL1 to the LLO.

In addition, in the second embodiment, although the transport ship 3 moves to the LLO, the destination of the transport ship 3 is not limited thereto, and the transport ship 3 may move to the earth E and a Lagrange point of the moon M.

### Third Embodiment

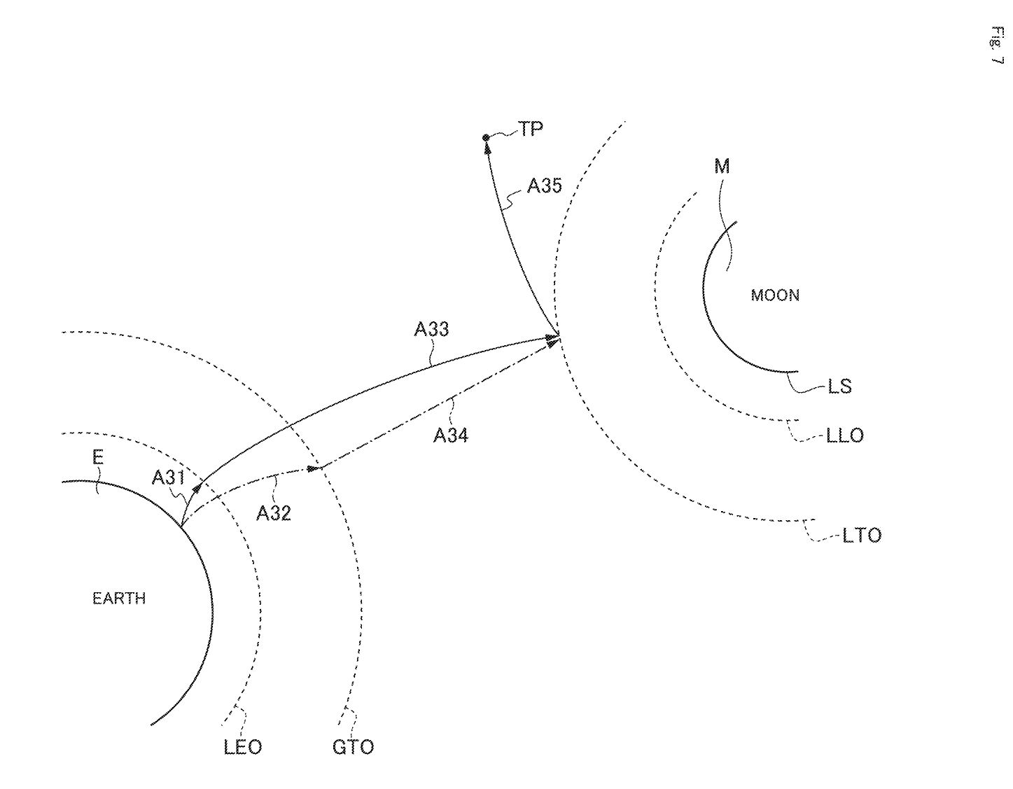

Next, a third embodiment will be described. FIG. 7 is a schematic diagram showing a route of a transport ship according to the third embodiment. A transport ship 3 according to the third embodiment is a transport ship transporting cargo in outer space, and transports cargo to a destination TP in deep space.

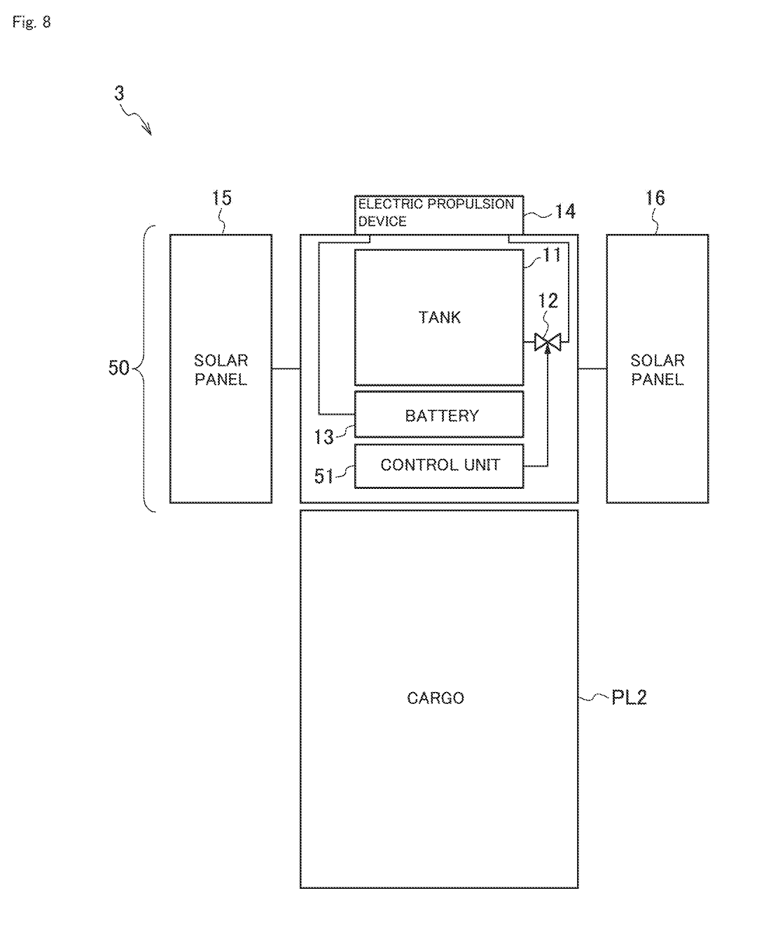

FIG. 8 is a schematic diagram showing a configuration of the transport ship according to the third embodiment. The transport ship 3 includes a fifth module 50 and a cargo PL2.

The fifth module 50 is configured to include a control unit 51 in addition to the first module 10. Components common to the first module 10 are denoted by the same reference numeral, and a description thereof is omitted.

The control unit 51 controls opening and closing of the valve 12. In addition, the control unit 51 performs control to separate the cargo PL2 from the transport ship 3. In addition, the control unit 51 controls the electric propulsion device 14. For example, the control unit 51 includes a sensor (for example, a gyro sensor) for attitude detection, and controls an attitude of the transport ship 3 using the electric propulsion device 14.

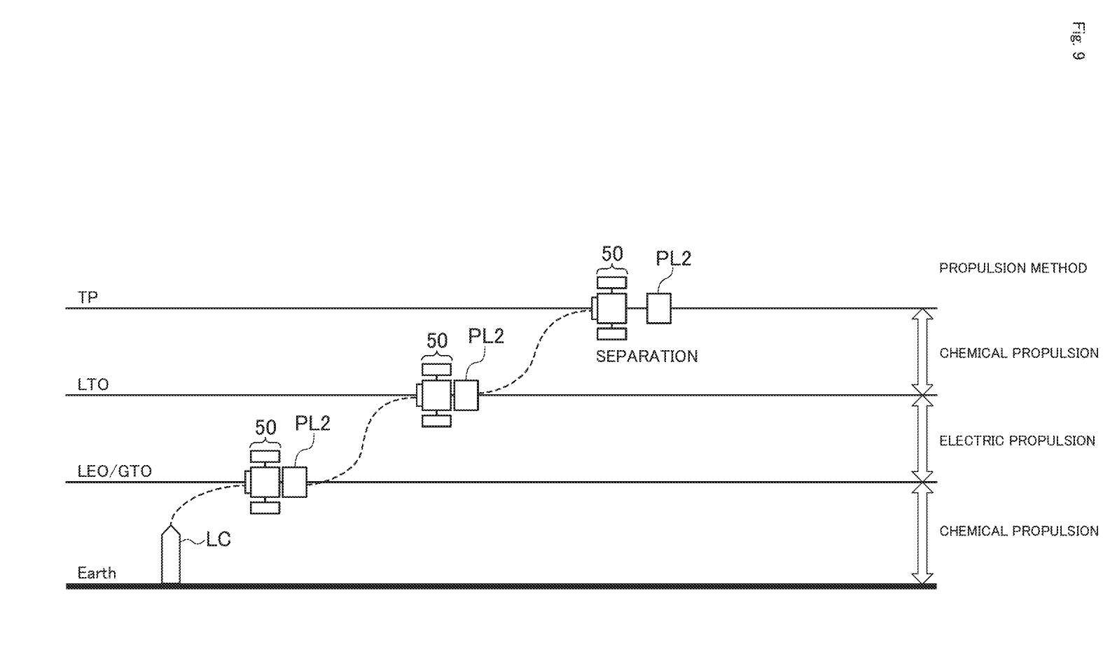

Subsequently, a route of a transport ship and a propulsion method for each section in the route will be described with reference to FIGS. 7 and 9. FIG. 9 is a schematic diagram showing a navigation process and a propulsion method of the transport ship according to the third embodiment. As shown in FIG. 9, the transport ship 3 is mounted on the launcher LC and launched from the earth E. The transport ship is launched to LEO as shown by arrow A31 in FIG. 7 or launched to GTO as shown by arrow A32 in FIG. 7. As shown in FIG. 9, in the LEO or the GTO, the transport ship 3 is separated from the launcher LC. Thereafter, in the transport ship 3, solar panels 15 and 16 on which the solar cells are mounted are unfolded. The transport ship 3 is propelled using power generated by the solar cells. As a result, the transport ship 3 moves from the LEO to LTO as shown by arrow A33 in FIG. 7 or moves from the GTO to the LTO as shown by arrow A34 in FIG. 7.

As described above, since the transport ship 3 moves from any of the LEO or the GTO to the LTO by the electric propulsion, the design of the transport ship can be common regardless of the orbit of the launch destination of the launcher LC on which the transport ship 3 is mounted. Thereby, the manufacturing cost of the transport ship can be reduced by mass production.

Thereafter, as shown in FIG. 9, the transport ship is propelled to a destination TP in deep space via the LTO. As a result, as shown by arrow A35 in FIG. 7, the transport ship 3 reaches the destination TP in deep space.

As described above, a transport method according to the third embodiment includes a first step of propelling a transport ship 3 from LEO or GTO to LTO by electric propulsion.

As a result, since the transport ship 3 moves from any of the LEO or the GTO to the LTO by the electric propulsion, the design of the transport ship can be common regardless of the orbit of the launch destination of the launcher LC on which the transport ship 3 is mounted. Thereby, the manufacturing cost of the transport ship 3 can be reduced by mass production. In addition, since fuel for chemical propulsion is not used from the LEO or the GTO to the LTO, the amount of propellant for chemical propulsion can be reduced, so a weight of the transport ship can be reduced and the launch cost can be reduced.

In addition, the transport ship 3 according to the third embodiment includes an electric propulsion device 14 propelled by electric propulsion, a tank 11 in which a propellant for the electric propulsion device is stored, and a control unit 51 which controls the opening and closing of the valve of the tank 11. As a result, the transport ship 2 can be propelled from the LEO/GEO to the destination TP in deep space.

The electric propulsion device 14, the tank 11, and the control unit 51 are mounted on one fifth module 50. As a result, since the fifth module 50 can be mass-produced, the manufacturing cost of the transport ship 3 can be suppressed and the manufacturing speed of the transport ship 3 can be increased.

In addition, in the third embodiment, the transport ship 3 passes the LLO as an example, but is not limited thereto, and may be propelled to the destination TP in deep space without passing the LLO.

As described above, the transport method according to each embodiment includes a first step of propelling a transport ship from LEO or GTO to a targeted orbit (for example, LTO) or a destination TP by electric propulsion.

By this configuration, since the transport ship moves from either the LEO or the GTO to the targeted orbit or the destination by the electric propulsion, the transport ship can be commonly designed regardless of orbits of launch destinations of the launchers on which the transport ships are mounted. Thereby, the manufacturing cost of the transport ship can be reduced by mass production. In addition, since fuel for chemical propulsion is not used from the LEO or the GTO to a targeted orbit or a destination, the amount of propellant for chemical propulsion can be reduced, so a weight of the transport ship can be reduced and the launch cost can be reduced.

In addition, the transport ship according to each embodiment includes the electric propulsion device 14 propelled by electric propulsion, the tank 11 in which the propellant for the electric propulsion device is stored, and the control unit 51 which controls the opening and closing of the valve of the tank 11. By this configuration, it is possible to adjust the amount of supply of the propellant to the electric propulsion device 14.

In addition, a method for manufacturing a transport ship according to each embodiment includes a step of manufacturing the transport ship using a first module 10, a second module 30, and a third module 20, a step of manufacturing the transport ship using the first module 10 and a fourth module 40, or a step of manufacturing the transport ship using a fifth module 50.

Here, the first module 10 includes the electric propulsion device 14 and the tank 11 in which the propellant of the electric propulsion device 14 is stored. The second module 30 includes a chemical propulsion device 34, a landing gear 35, and a control unit 33 which controls the opening and closing of a valve 12 of the tank 11 of the first module 10. The third module 20 has a tank 21 in which fuel for the chemical propulsion device 34 is stored. The fourth module includes a chemical propulsion device 44 and a control unit 43 which controls the opening and closing of the valve 12 of the tank 11 of the first module 10. The fifth module 50 includes the electric propulsion device 14, the tank 11 in which the propellant of the electric propulsion device 14 is stored, and a control unit 51 which controls the opening and closing of the valve of the tank 11.

By this configuration, it is possible to reduce the manufacturing cost of the transport ship and increase the manufacturing speed of the transport ship by mass-producing the first to fifth modules 10 to 50. In addition, the transport ship manufactured using the first module 10, the second module 30, and the third module 20 can land on the moon, asteroids, and the like as in the first embodiment. In addition, the transport ship manufactured using the first module 10 and the fourth module 40 can transport a cargo to the LLO as in the second embodiment. In addition, the transport ship manufactured using the fifth module 50 can transport the cargo to the destination TP in deep space as in the third embodiment. Therefore, according to the manufacturing method, it is possible to manufacture the transport ship which can move to any point in space.

In addition, although the example in which two solar panels are provided is described in each embodiment, these embodiments are not limited thereto and the number of solar panels may be one or three or more.

### Fourth Embodiment

Next, a fourth embodiment will be described. A lander according to the fourth embodiment can be configured so that after a drawer having a payload mounted therein is removed from the lander, another drawer can be connected and mounted.

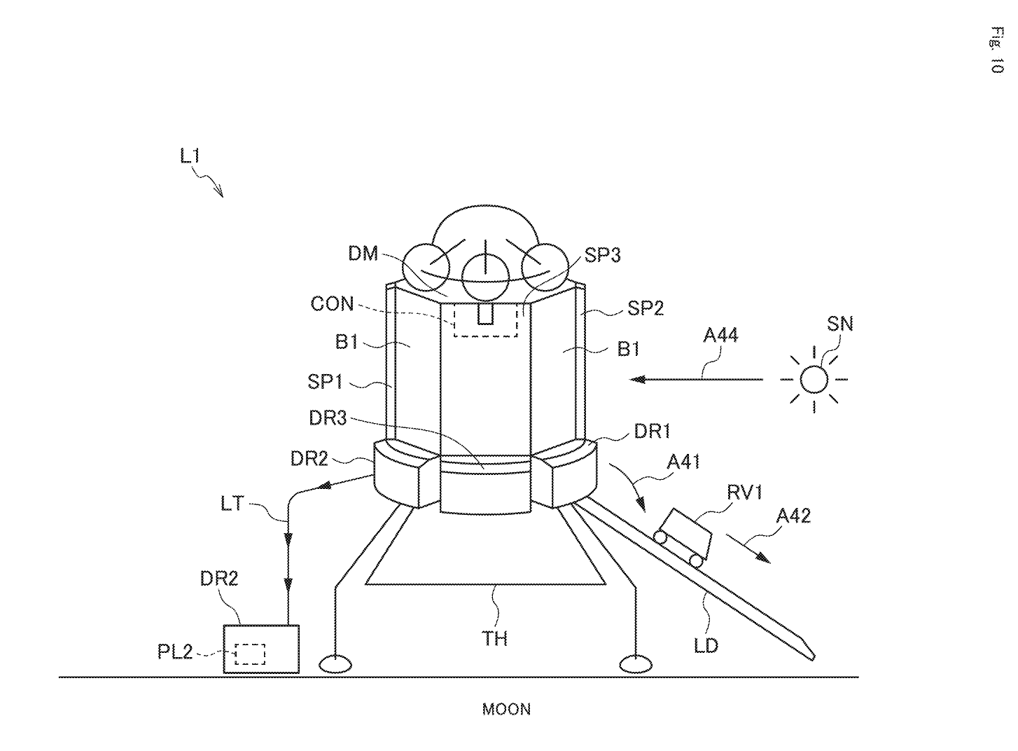

FIG. 10 is a schematic diagram showing the lander according to the fourth embodiment. As shown in FIG. 10, a lander L1 includes a housing B1 and solar panels SP1, SP2, and SP3 provided on a surface of the housing B1. In addition, the lander L1 further includes a drive mechanism DM which changes an inclination of a solar panel with respect to a horizontal plane and a controller which controls the drive mechanism. In addition, the lander L1 is provided with a thruster TH.

As shown in FIG. 10, the lander L1 lands on a lunar surface in a state in which drawers DR1 to DR3 are mounted. The drawers DR1 to DR3 have the payload mounted therein. As an example, the drawer DR1 has a space probe RV1 as the payload mounted thereon.

The lander L1 is provided with a ladder LD, and after landing, the ladder LD lowers to a lunar surface. Then, the drawer DR1 mounted on the lander L1 is removed, and as shown by arrow A41, the space probe RV1 in the drawer DR1 comes out of the drawer DR1. In addition, as shown by arrow A42, the space probe RV1 lowers the ladder LD to land on the lunar surface.

In addition, the lander L1 is provided with a lift LT, and after landing, the lift LT lowers a drawer DR2 onto the lunar surface.

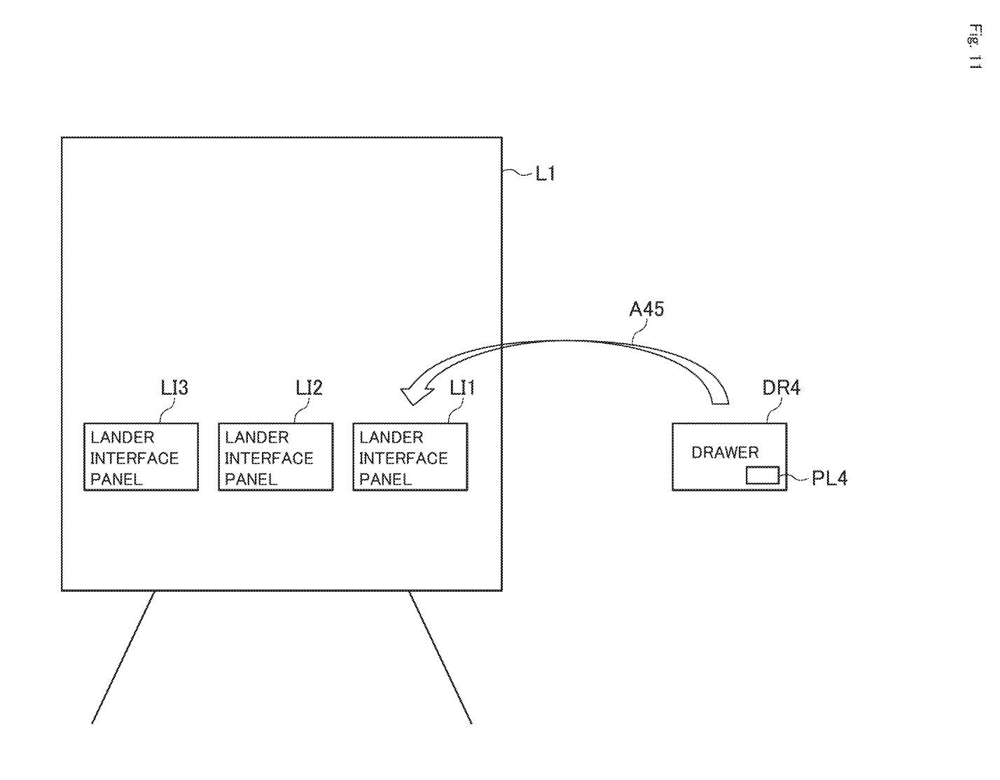

FIG. 11 is a schematic diagram for describing a lander interface panel of the lander according to the fourth embodiment. As shown in FIG. 11, the lander L1 includes lander interface panels LI1, LI2, and LI3. After the drawer DR1 in FIG. 10 is removed from the lander interface panel LI1, as indicated by arrow A45, another drawer DR4 can be connected to the lander interface panel LI1. Here, the drawer DR4 is mounted with the payload PL4. As a result, the lander L1 can take off from the moon and navigate to the earth and the like after the drawer DR4 mounted with the payload PL4 is connected. For example, if the payload PL4 is a natural resource extracted on the moon, this natural resource can be transported to the earth or the like.

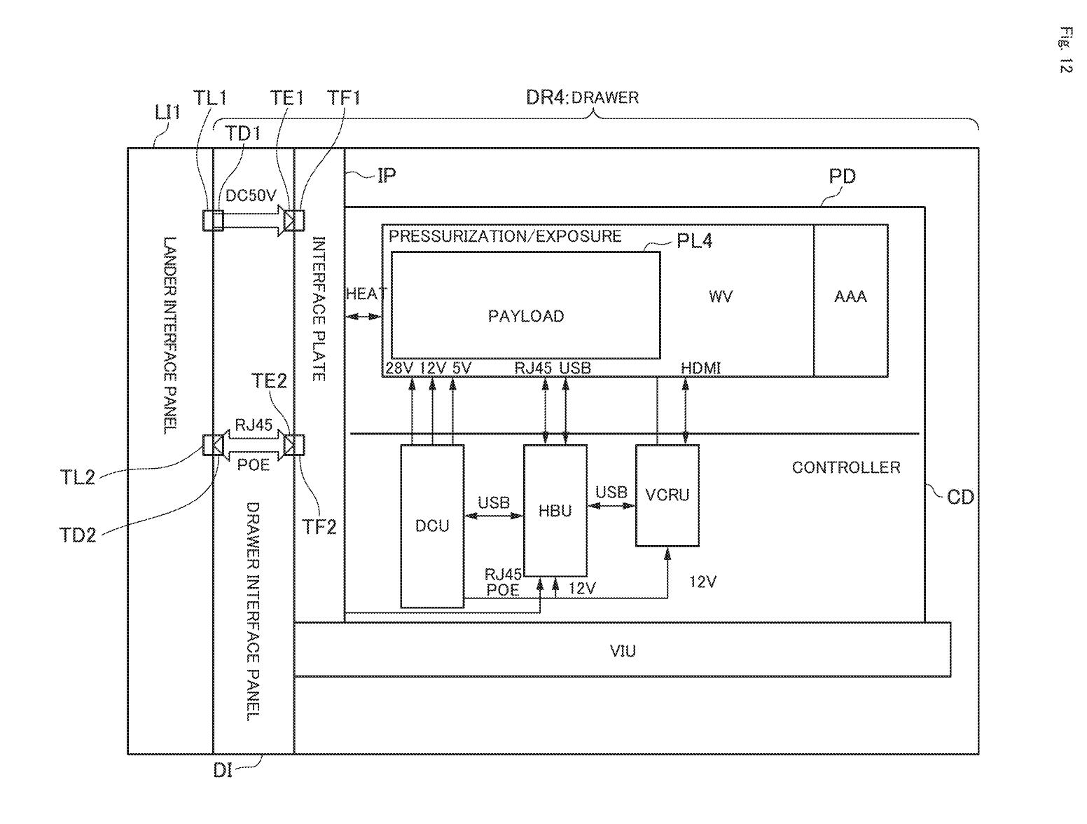

FIG. 12 is a block diagram showing a schematic configuration of the drawer according to the fourth embodiment. As shown in FIG. 12, the lander interface panel LI1 is for connecting between the lander and a drawer interface panel DI of the drawer DR4 in which the payload PL4 is mounted.

The lander interface panel LI1 has a voltage output terminal TL1 which connects between the drawer interface panel DI and the lander to supply a voltage to the payload PL4 through the drawer interface panel DI.

In addition, the lander interface panel LI1 has a signal terminal TL2 which connects between the drawer interface panel DI and the lander to exchange a signal with a controller CD mounted on the drawer DR4 via the drawer interface panel DI.

By this configuration, a voltage can be supplied from the lander L1 to the payload PL4, and the lander L1 can communicate with the payload PL4 via the controller CD.

As shown in FIG. 12, the drawer DR4 includes the drawer interface panel DI, an interface plate IP connected to the drawer interface panel DI, and a vibration isolation unit VIU which reduces a transmission of launch/landing vibration.

In addition, the drawer DR4 includes the controller CD and a heat insulating structure PD which insulates heat from the interface plate IP.

The controller CD includes a DC converter unit DCU, a hub unit HBU, and a video compression recording unit VCRU.

The DC converter unit DCU converts DC 50 V fed from the lander into an appropriate voltage and supplies the voltage to the payload.

The hub unit HBU is connected to the payload PL4 as a communication hub with the lander L1.

The video compression recording unit VCRU records data acquired from the payload PL4.

heat insulating structure PD can be mounted with various payloads (for example, small payloads). Here, the heat insulating structure PD includes a payload PL4, a housing WV in which the payload is stored, and an avionics air assembly AAA.

The housing WV has a mechanical, thermal, and electrical interface and can be pressurized.

The drawer interface panel DI includes a voltage input terminal TD1 which can be conducted with the voltage output terminal TL1, a voltage output terminal TE1, a signal input terminal TD2 which can be conducted with the signal terminal TL2, and a signal output terminal TE2. The interface plate TF1 includes a voltage input terminal TF1 which can be conducted with the voltage output terminal TE1, and a signal input terminal TF2 which can be conducted with the signal output terminal TE2.

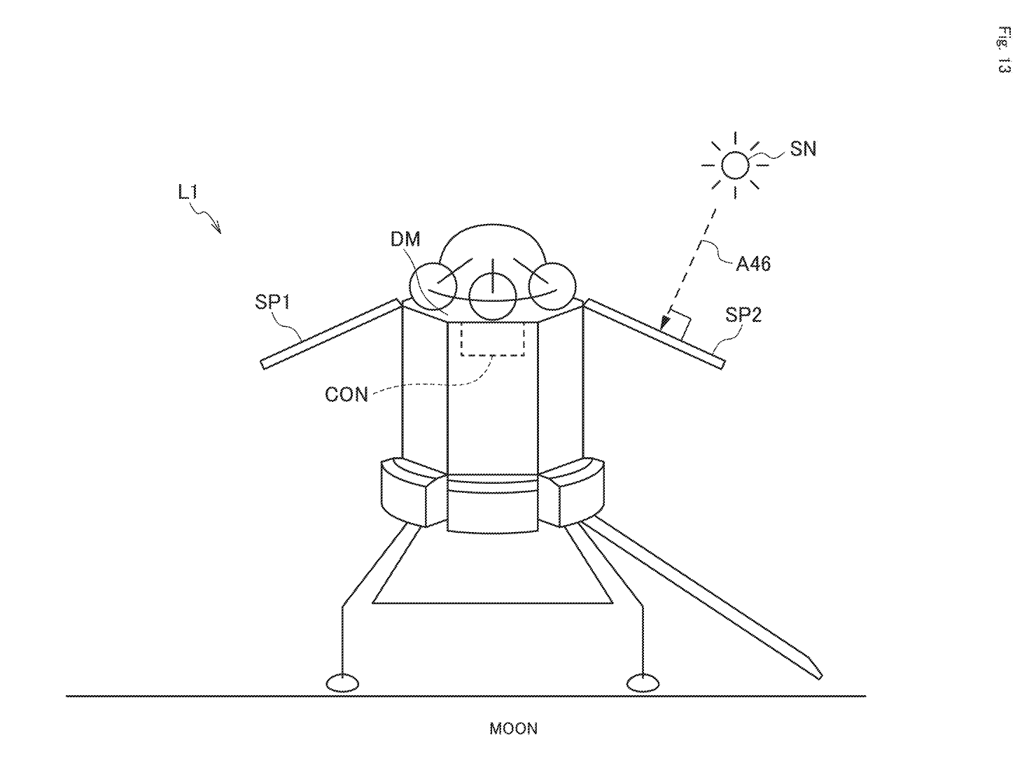

FIG. 13 is a schematic diagram showing a change in inclination of a solar panel of a lander with respect to a horizontal plane when sunlight falls obliquely downward. In FIG. 10 described above, for example, as shown by arrow A44, the sun SN is located at a position where sunlight hits the lander horizontally. Thereby, solar panels SP1 to SP3 are disposed substantially perpendicular to a water surface.

On the other hand, in FIG. 13, as shown by arrow A46, the sun SN is located at a position where sunlight hits the lander obliquely downward. As shown in FIG. 13, a controller CON controls the drive mechanism DM to change the inclination of the solar panels SP1 and SP2 with respect to the horizontal plane. At that time, for example, the controller CON controls the drive mechanism DM to change the inclination of the solar panels SP1 and SP2 with respect to the horizontal plane depending on, for example, time, a position (for example, an angle of the sun based on the horizontal plane) of the sun SN, or a power generation amount of the solar panels SP1 and SP2. As a result, as shown by arrow A46 in FIG. 13, for example, it is possible to make sunlight hit the solar panel SP2 substantially perpendicularly. The controller CON can change the inclination of the solar panel SP2 with respect to the horizontal plane depending on an irradiation angle of the sunlight and increase the amount of light hitting the solar panel SP2, thereby increasing the power generation amount of the solar panel SP2.

### Modified Example of Fourth Embodiment

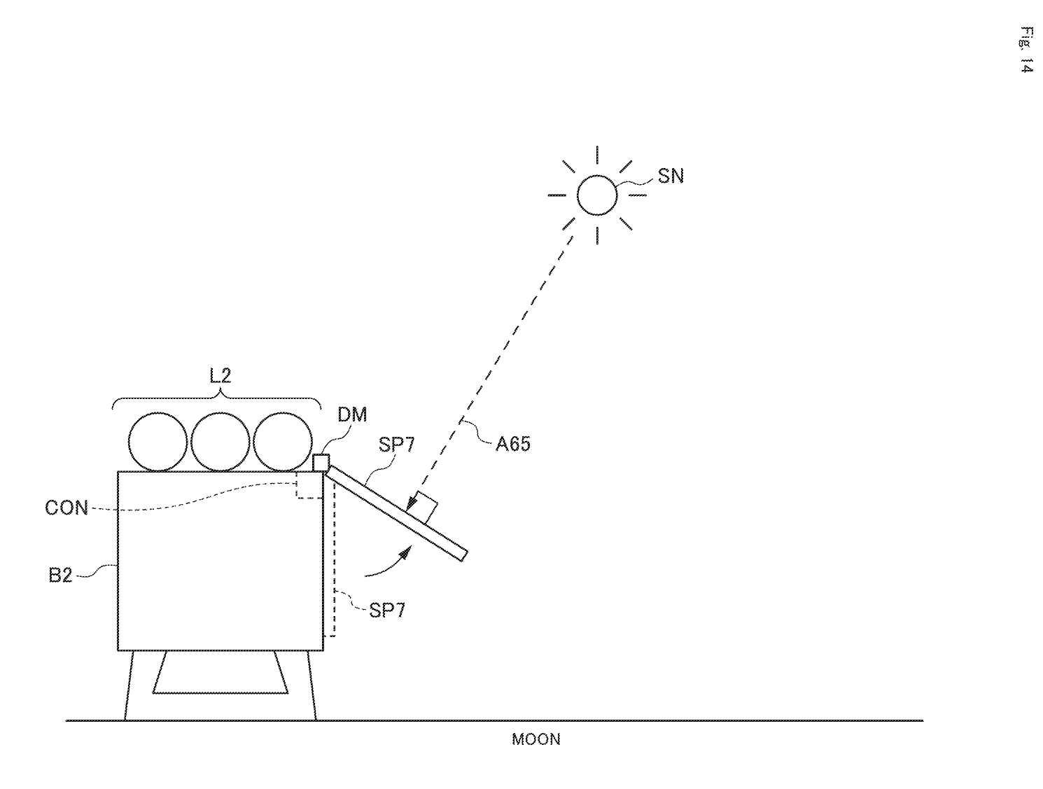

FIG. 14 is a schematic diagram showing a lander according to a modified example of the fourth embodiment. As shown in FIG. 14, a lander L8 according to the modified example of the fourth embodiment includes a housing B2, a solar panel SP7 provided on a side surface of the housing B2, and a drive mechanism DM which changes an inclination of the solar panel SP7 with respect to a horizontal surface, and a controller CON which controls the drive mechanism DM. The controller CON controls the drive mechanism DM to change the inclination of the solar panel SP7 with respect to the horizontal plane depending on, for example, time, a height of the sun SN, or a power generation amount of the solar panel SP7. As a result, as shown by arrow A65 in FIG. 13, for example, it is possible to make sunlight hit the solar panel SP7 substantially perpendicularly. As described above, the controller CON can change the inclination of the solar panel SP7 with respect to the horizontal plane depending on the position of the sun, and can increase the power generation amount of the solar panel SP7.

In addition, the position of the solar panel SP7 is provided on the side surface of the housing B2, but is not limited thereto, and the solar panel SP7 may be positioned on an upper surface or a lower surface of the housing B2. In addition, when the solar panel SP7 has flexibility, the solar panel SP7 may be wound like a carpet, and when the solar panel SP7 intends to generate electricity, the wound solar panel SP7 may be unfolded.

### Fifth Embodiment

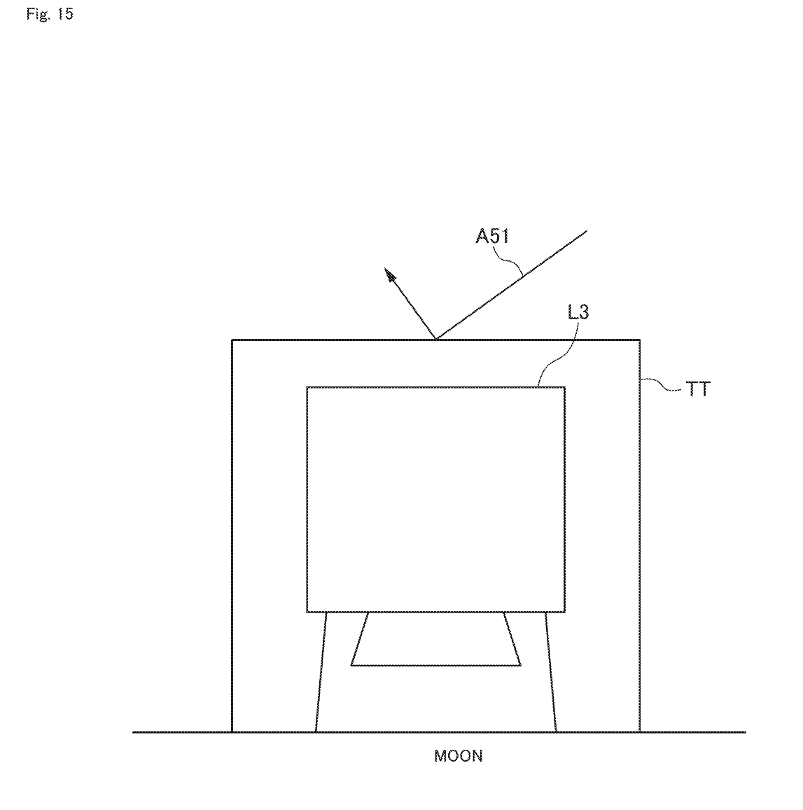

Subsequently, a fifth embodiment will be described. In a heat insulating method according to the fifth embodiment, an outer side of a lander is covered with a heat insulating sheet made of a material having heat insulating property. FIG. 15 is a schematic diagram showing a use state of a heat insulating sheet according to the fifth embodiment. A lander L3 is folded and stored, and includes a heat insulating sheet TT which can be unfolded from the folded state. As shown in FIG. 15, the heat insulating sheet TT is configured to cover the outer side of the lander L3 when being unfolded. The outer side of the lander L3 is covered with the heat insulating sheet TT. As a result, as shown by arrow A15, since the heat insulating sheet TT reflects sunlight and has heat insulating property, the change in temperature of the lander L3 can be reduced. The heat insulating sheet TT is preferably self-supported.

The lander L3 may include a gas discharge mechanism which discharges a gas into the heat insulating sheet TT in a state in which the heat insulating sheet TT is folded and a controller which controls the gas discharge mechanism. As a result, the controller may control the gas discharge mechanism to discharge the gas into the heat insulating sheet TT in the state in which the heat insulating sheet TT is folded. As a result, since the heat insulating sheet is expanded by the gas from the state in which the heat insulating sheet TT is folded, an outer side of a lander L3 can be covered with the heat insulating sheet TT.

### Sixth Embodiment

Next, a sixth embodiment will be described. In a navigation method according to the sixth embodiment, a navigation method of a spacecraft from a geostationary transfer orbit (GTO) to celestial bodies (for example, the moon, asteroids, planets, or comets) other than the earth or orbits of the celestial bodies is made common regardless of an orbit of a first launch destination. As a result, it is possible to navigate the spacecraft to the targeted celestial body regardless of the orbit of the first launch destination. The spacecraft is, for example, a transport ship, and since the spacecraft is loaded with a payload, the payload can be transported to celestial bodies (for example, the moon, asteroids, planets, or comets) other than the earth or the orbits of the celestial bodies.

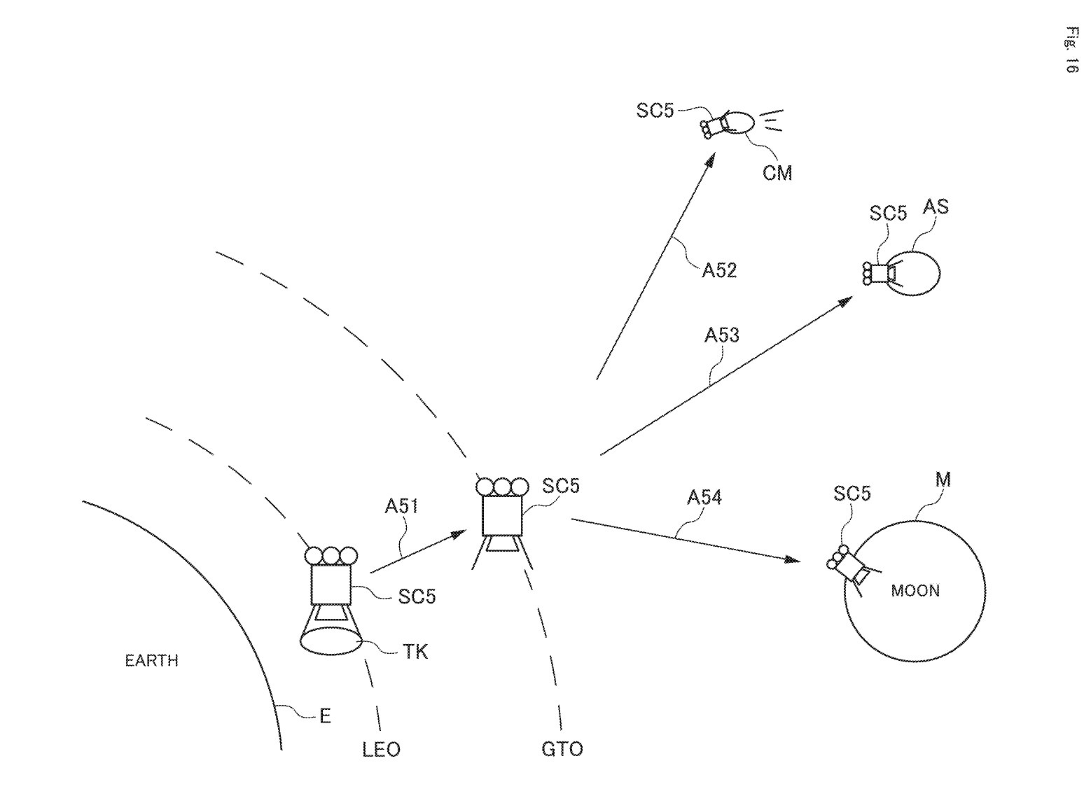

FIG. 16 is a schematic diagram for describing the navigation method according to the sixth embodiment. For example, when the first launch destination is LEO, as shown by arrowA51, a spacecraft SC5 mounted with a fuel tank TK is propelled to GTO by using the fuel in the fuel tank TK. The spacecraft SC5 which reaches the GTO separates the fuel tank TK.

Thereafter, the spacecraft SC5 determines the propulsion destination according to the destination and is propelled. For example, the spacecraft SC5 is propelled to a comet CM as shown by arrow A52. Alternatively, the spacecraft SC5 is propelled to an asteroid AS as shown by arrow A53. Alternatively, the spacecraft SC5 is propelled to the moon M as shown by arrow A54. On the other hand, when the first launch destination is the GTO, the navigation method from the GTO to a targeted celestial body other than the earth is the same.

### Seventh Embodiment

Next, a seventh embodiment will be described. In a manufacturing method of the seventh embodiment, components of a lander are manufactured by a 3D printer disposed on celestial bodies (for example, a planet, a secondary planet, an asteroid, or a comet) other than the earth. The component of the lander may include a tank, a solar panel, a thruster, a meter, electrical harnesses, a wiring of propellant, and the like. As a result, when the component of the lander is broken or damaged, the component of the lander can be manufactured by a 3D printer on a celestial body other than the earth, and the manufactured component can be replaced with the broken component.

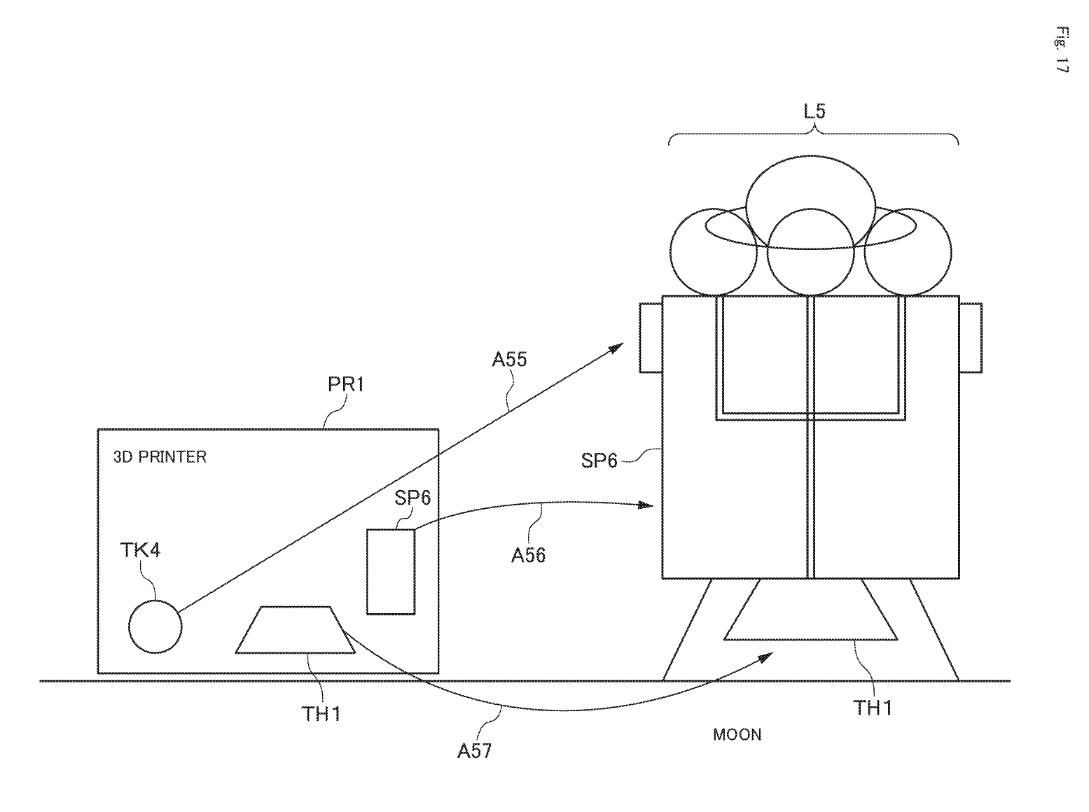

FIG. 17 is a schematic view for describing an example of the manufacturing method according to the seventh embodiment.

As shown in FIG. 17, a 3D printer PR1 disposed on a lunar surface manufactures a fuel tank TK4, a solar panel SP6, and a thruster TH1. Then, the fuel tank TK4 obtained by manufacturing is attached to a lander L5 as shown by arrow A55. Similarly, the solar panel SP6 obtained by manufacturing is attached to the lander L5 as shown by arrow A56. Similarly, the thruster TH1 obtained by manufacturing is attached to the lander L5 as shown by arrow A57. The attachment may be made manually by an astronaut on the lunar surface, may be made by allowing an astronaut to manipulate a robot arm, or may be made by allowing a robot to manipulate its own arm.

When the components of the lander are broken or damaged, the broken or damaged components of the lander are melted, and materials obtained after the melting may be used as a raw material to manufacture components (for example, the same components as the broken or damaged components of the lander) of a spacecraft with the 3D printer. As a result, when the components of the lander are broken or damaged, the components of the lander can be reused to manufacture the components of the spacecraft. In particular, when for example, the same broken or damaged components of the lander are manufactured as the components of the spacecraft with the 3D printer, the broken or damaged components can be reused to manufacture the same components of the lander. The 3D printer is not limited to the manufacturing of the same components, and may manufacture other components of the lander or components of another spacecraft (for example, a space probe).

According to the above description, the method for manufacturing a lander on celestial bodies other than the earth includes a step of melting broken or damaged components of the lander, a step of manufacturing a component of the lander with a 3D printer on the celestial bodies (for example, a planet, a secondary planet, an asteroid, or a comet) other than the earth by using a material obtained after the melting as a raw material, and a step of attaching the manufactured component of the lander to a targeted lander. By this configuration, even if the component of the lander is broken or damaged, the lander can be regenerated.

Furthermore, after the component is attached, resources (for example, natural resources such as minerals and rare metals) extracted from the celestial bodies for example, a planet, a secondary planet, an asteroid, or a comet) other than the earth are mounted on the targeted lander, and the targeted lander takes off. As a result, it is possible to transport resources to the earth, a space station, and a spacecraft in outer space.

### Modified Example of Seventh Embodiment

Next, a modified example of the seventh embodiment will be described. According to the modified example of the seventh embodiment, a space probe extracts natural resources (for example, minerals) from the moon, and a 3D printer uses the natural resources (for example, minerals) extracted from the moon as raw materials to manufacture components (for example, thruster) of a lander. By this configuration, it is possible to manufacture the components of the lander more inexpensively.

Here, when a solar panel is manufactured, an example of the minerals may include silica contained in, for example, a regolith of a lunar surface. In addition, in order to manufacture the thruster, an example of the minerals may include aluminum contained in rocks.

Then, the manufactured components (for example, thruster) are attached to the lander, and then the lander mounted with resources (for example, minerals and the like) extracted from the moon takes off. As a result, it is possible to manufacture the components of the lander using natural resources extracted from the moon more inexpensively, and transport other natural resources extracted from the moon to the earth inexpensively.

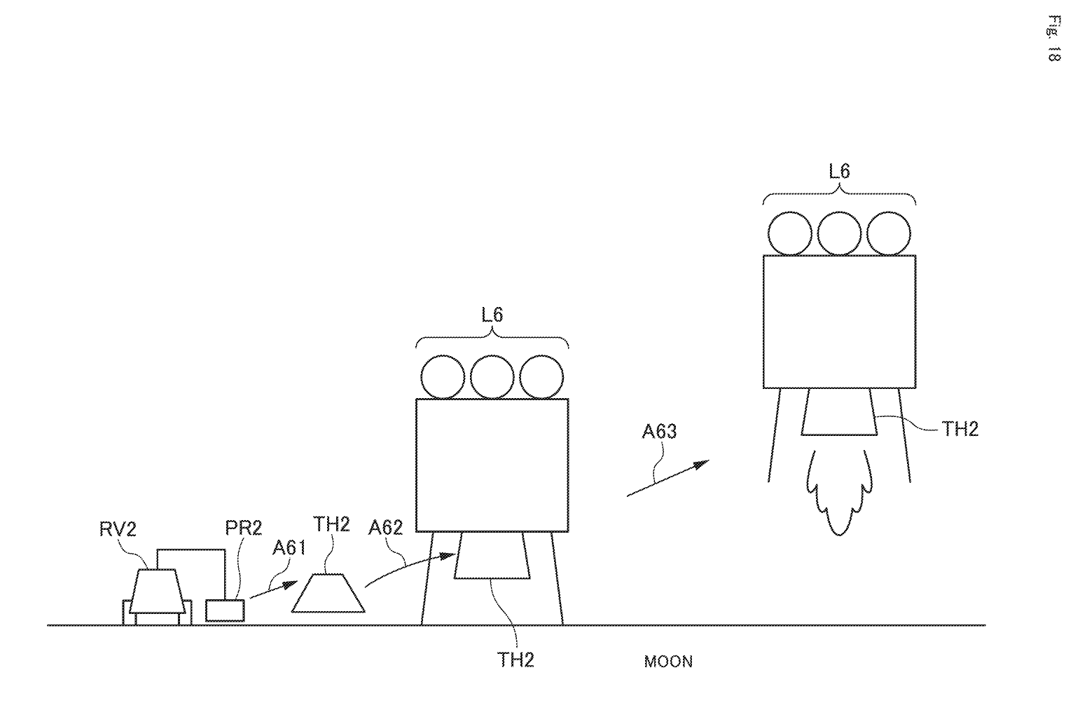

FIG. 18 is a schematic view for describing an example of a manufacturing method according to the modified example of the seventh embodiment. As shown in FIG. 18, first, a space probe RV2 extracts rock from the moon. Here, rock is an aggregate of minerals or rock fragments and is not chemically homogeneous. Then, the space probe RV2 extracts a targeted mineral (for example, crystal of aluminum) from rock as needed, or refines a targeted metal (for example, aluminum). Here, minerals are chemically almost homogeneous and have a 3D ordered array (crystal structure) at an atom and ion level. As shown by arrow A61, a 3D printer PR2 manufactures a thruster TH2 using minerals (for example, crystal of aluminum) or metals (for example, aluminum) extracted from the moon as raw materials.

Next, as shown by arrow A62, the thruster TH2 is attached to a lander L6. In addition, resources (for example, natural resources such as minerals extracted from the moon) are mounted on the lander L6. Thereafter, as shown by arrow A63, the thruster TH is ignited to take off the lander L6, and the lander L6 transports the resources to the earth, a space station, a spacecraft or an artificial satellite in outer space.

As described above, the method for manufacturing a lander according to the modified example of the seventh embodiment includes a step of extracting a natural resource in celestial bodies (for example, a planet, a secondary planet, an asteroid, or a comet) other than the earth, a step of manufacturing a component of a lander with a 3D printer by using the extracted natural resource as a raw material, and a step of attaching the manufactured component of the lander to a targeted lander L6.

By this configuration, since the component of the lander is manufactured using as a raw material the natural resources extracted from the celestial bodies (for example, a planet, a secondary planet, an asteroid, or a comet) other than the earth, it is possible to manufacture the lander more inexpensively.

Furthermore, after the component is attached, the targeted lander L6 is mounted with resources, and the targeted lander L6 takes off. As a result, it is possible to transport resources to the earth, the space station, or the artificial satellite more inexpensively.

### Eighth Embodiment

Next, an eighth embodiment will be described. A lander according to the eighth embodiment includes movable legs or wheels which are movable so as to be movable on celestial bodies (for example, a planet, a secondary planet, an asteroid, or a comet) other than the earth. By this configuration, the lander can move on the celestial bodies (for example, a planet, a secondary planet, an asteroid, or a comet) other than the earth.

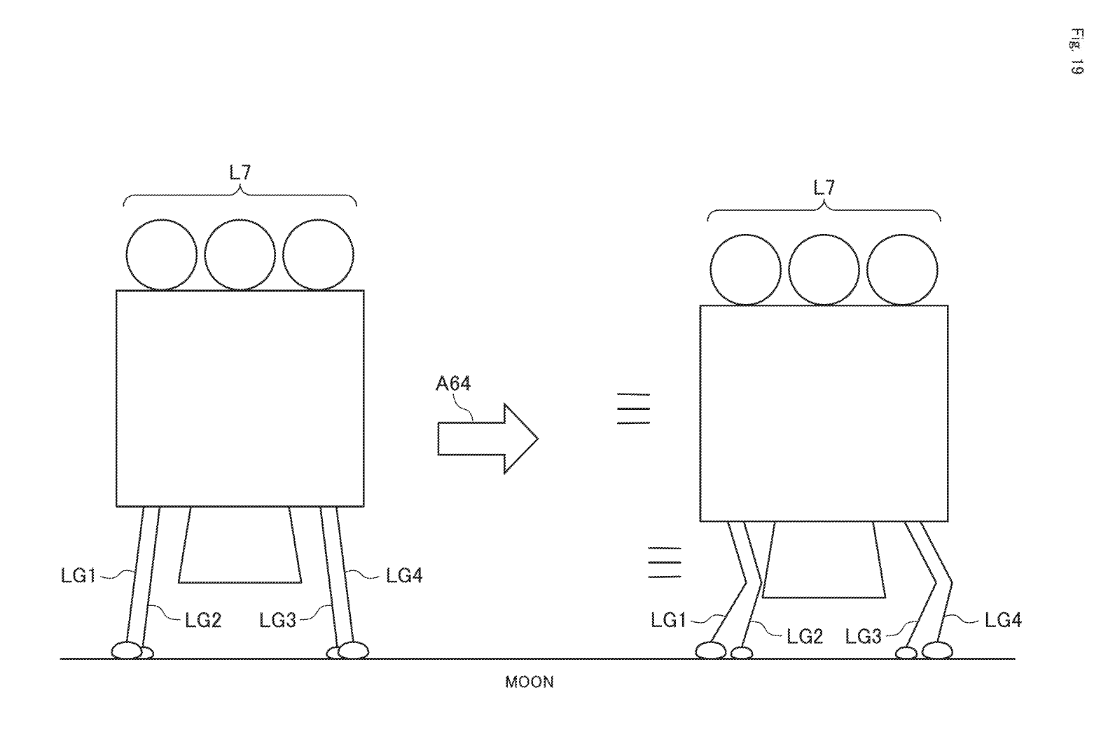

FIG. 19 is a schematic diagram for describing an operation of the lander according to the eighth embodiment. As shown in FIG. 19, the lander L6 according to the eighth embodiment includes movable legs LG1 to LG4. The lander L6 moves the movable legs LG1 to LG4 to move on a lunar surface as shown by arrow A64.

The lander L6 may have wheels instead of the movable legs LG1 to LG4

### Ninth Embodiment

Next, a ninth embodiment will be described. A lander according to the ninth embodiment includes a reflector which reflects light, in which a direction of the reflector is set so that a solar panel of an object (for example, another lander) is irradiated with sunlight reflected from the reflector. By this configuration, since the object can be irradiated with the reflected light, a power generation amount in the solar panel of the object can be increased.

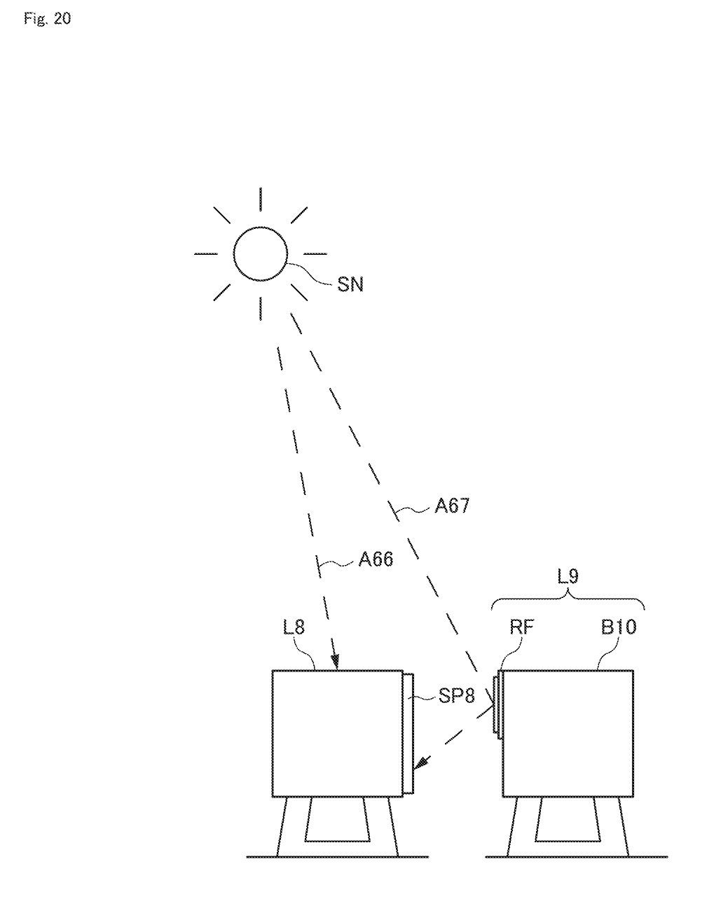

FIG. 20 is a schematic diagram showing a configuration of the lander according to the ninth embodiment. As shown by arrow A66 in FIG. 20, sunlight is applied to a lander L8 which is an example of the object. The lander L8 includes a solar panel, and a lander L9 according to the ninth embodiment includes a housing B10 and a reflector RF provided on a surface of the housing B10. A direction of the reflector is set so that the solar panel of another lander L6 is irradiated with sunlight reflected from the reflector RF.

As a result, as shown by arrow A67, the reflector RF reflects sunlight, and a solar panel SP8 of another lander L8 which is an object is irradiated with the reflected sunlight. Therefore, it is possible to increase the irradiation amount of light to the solar panel SP8 and the power generation amount in the solar panel SP8.

### Tenth Embodiment

Next, a tenth embodiment will be described. A landing method according to the tenth embodiment is a method for landing a lander on celestial bodies (for example, a planet, a secondary planet, an asteroid, or a comet) other than the targeted earth, and includes a step of wirelessly transmitting a response request to any spacecraft (for example, a lander, a space probe, and the like) existing on the celestial bodies (for example, a planet, a secondary planet, an asteroid, or a comet) other than the targeted earth, a step of receiving the response signal including a position of a self-controlled spacecraft which is transmitted in response to the response request, and a step of landing the lander while avoiding the position included in the response signal By this configuration, the lander can land while avoiding any spacecraft existing on the celestial bodies (for example, planets, secondary planets, asteroids, comets or the like) other than the earth.

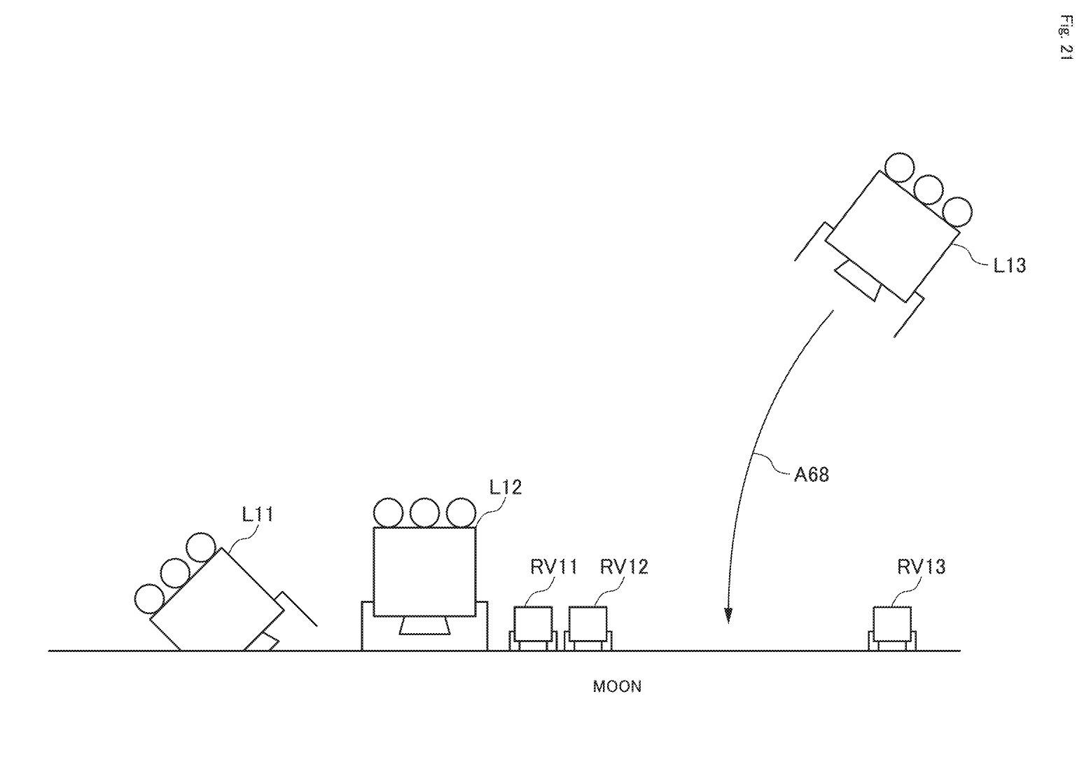

FIG. 21 is a schematic diagram for describing a landing method according to the tenth embodiment. As shown in FIG. 21, it is assumed that there is a broken lander L11, a normal lander L12, and normal space probes RV11, RV12, and RV13 on the moon. A lander L13 which is scheduled to land on a lunar surface wirelessly transmits a response request to any lander and space probe existing on the lunar surface. The lander L12 and the space probes RV11 to RV13 having received the response request transmit a response signal including their own positions in response to the response request.

The lander L13 receives the response signal transmitted in response to the response request. Then, the lander L13 lands while avoiding the position included in the response signal as shown by the arrow A68. At this time, for example, the lander L13 compares the pre-scheduled landing position with the positions of the lander L12 and the space probes RV11 to RV13. For example, when the scheduled landing position is within a set distance range based on the positions of the lander L12 and the space probes RV11 to RV13, the scheduled landing position is changed so as to be out of the set distance range based on the positions of the lander L12 and the space probes RV11 to RV13. The lander L13 lands on the changed scheduled landing position.

As a result, as shown by arrow A68, the lander L13 can land while avoiding the lander L12 and the space probes RV11, RV12, and RV13 present on the lunar surface.

It is to be noted that the broken lander L11, the normal lander L12, and the normal space probes RV11, RV12, and RV13 may have reflectors, which reflect sound waves or ultrasonic waves, provided on surfaces thereof. In this case, the lander L13 which is scheduled to land on the lunar surface may emit sound waves or ultrasonic waves toward the lunar surface, and capture waves reflected from the reflector to specify positions of structures (for example, the landers L11 and L12, the space probes RV11, RV12, and RV13, and the like) on the lunar surface. In this case, the lander L13 lands while avoiding the specified position. As a result, the lander L13 can land avoiding the structures on the lunar surface. As a result, it is possible to prevent the lander L13 from colliding with the structures (for example, the landers L11 and L12 and the space probes RV11, RV12 and RV13) of the lunar surface.

The lander L13 may include a camera. In this case, the lunar surface is photographed with a camera, and the landing direction may be adjusted by using an image (still or moving image) obtained by the photographing so that the lander L12 and the space probes RV11 to RV13 do not exist in the landing direction. As a result, it is possible to prevent the lander L13 from colliding with the lander L12 and the space probes RV11, RV12, and RV13.

In addition, the lander L13 may include a camera, and the lander L12 and the space probes RV11, RV12, and RV13 may have a lamp (for example, LED or the like) and a controller which controls the lamp. In this case, the controller of the lander L12 and the space probes RV11, RV12, and RV13 may turn on the lamp when receiving the response request from the lander L13.

As a result, the lander L13 may photograph the lunar surface with a camera, extract the position of the lamp included in the image (still image or moving image) obtained by the photographing, and use the position of the lamp to adjust the landing position or the landing direction. As a result, it is possible to prevent the lander L13 from colliding with the lander L12 and the space probes RV11, RV12, and RV13.

### Eleventh Embodiment

Next, an eleventh embodiment will be described. A landing method according to the eleventh embodiment is a method for landing a lander on celestial bodies (for example, a planet, a secondary planet, an asteroid, or a comet) other than the earth, and acquires map data of a celestial body scheduled to land from an artificial satellite by wireless communication and determines whether or not a zone scheduled to land is an unstable zone based on the map data. Here, the unstable zone is a zone where unevenness of a ground is larger than a reference, a zone where an angle of a slope is larger than a reference, an underground of a longitudinal hole such as a crater, and the like. As the determination result, in the case of the unstable zone, a thruster of the lander is ignited so as to land in different zones. By this configuration, the lander can land while avoiding the unstable zone.

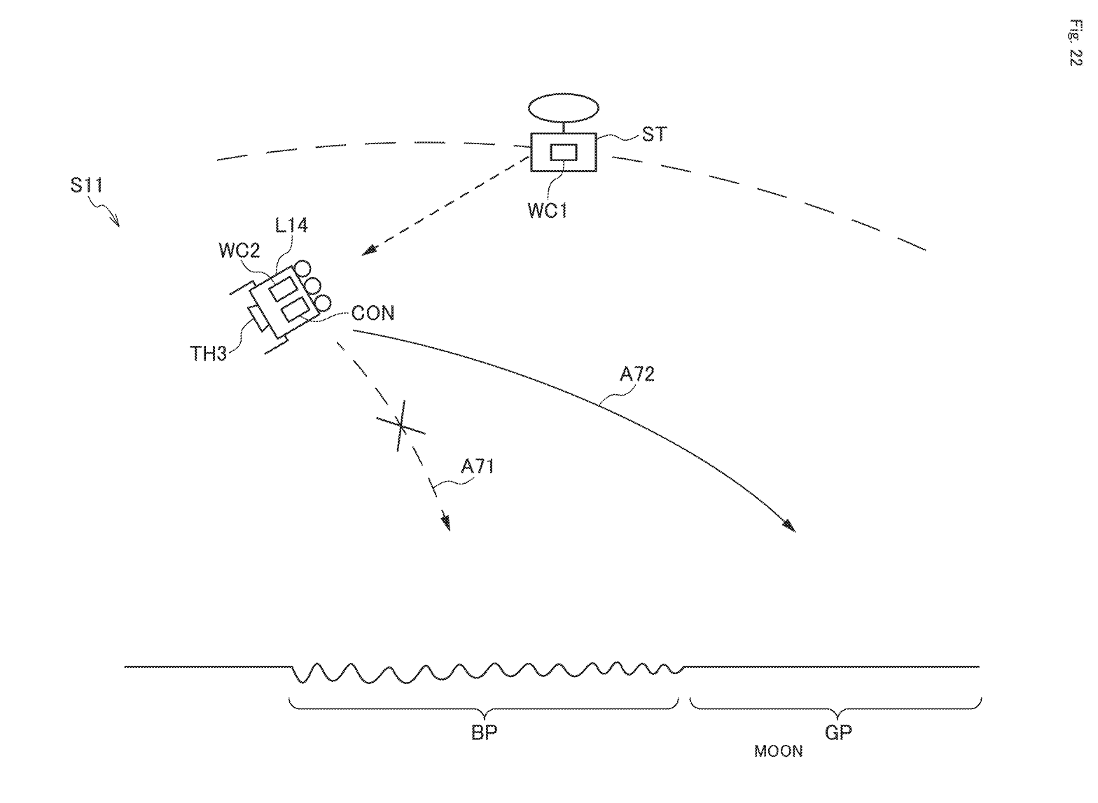

FIG. 22 is a schematic diagram for describing the landing method according to the eleventh embodiment. As shown in FIG. 22, a landing route of a lander L14 in the case of a pre-scheduled landing position is shown by the arrow A71. An unstable zone BP is, for example, a zone where unevenness of a ground is larger than a reference, and a stable zone GP is, for example, a zone where the unevenness of the ground is lower than the reference.

As shown in FIG. 22, a transport system S11 includes an artificial satellite ST and a lander L14. Here, the artificial satellite ST includes a communication unit WC1. The lander L14 includes a communication unit WC2, a controller CON, and a thruster TH3.

First, the communication unit WC2 of the lander L14 asks the artificial satellite ST for map data of the moon scheduled to land. In response to this request, the communication unit WC1 of the artificial satellite ST transmits the map data to the lander L14. As a result, the communication unit WC2 of the lander L14 acquires from the artificial satellite ST the map data of the moon scheduled to land by wireless communication.

Next, the controller CON of the lander L14 determines, using the acquired map data, whether or not a zone scheduled to land on the moon is an unstable zone. If the zone scheduled to land on the moon is not an unstable zone, the lander L14 will land as it is. Here, as shown in FIG. 22, since the zone scheduled to land on the moon is an unstable zone as an example, the controller CON ignites the thruster TH3 of the lander L14 to land the lander L14 on different zones. As a result, as shown by arrow A72, the landing orbit is changed, and the lander L14 can land in the stable zone GP.

The lander L14 may also include a camera. In this case, the controller CON may photograph the lunar surface with the camera, and determine whether or not the zone scheduled to land on the moon is an unstable zone based on an image obtained by the photographing.

In addition, the controller CON of the lander L14 compares the map data of the moon stored in its own memory in advance with its own position to determine whether or not the zone scheduled to land on the moon is an unstable zone. Here, for example, the controller CON estimates its own position from a navigation route so far. The controller CON may control the thruster TH to land in the stable zone when the zone scheduled to land on the moon is an unstable zone.

In addition, the lander L14 may also include a laser irradiator and a camera. In that case, the controller CON may determine whether or not there is an obstacle at the position of the laser beam irradiated by the laser irradiator based on an image photographed with a camera. When there is an obstacle, the controller CON may also control the thruster TH so as to avoid the obstacle.

### Twelfth Embodiment

Next, a twelfth embodiment will be described. In a monitoring method according to the twelfth embodiment of the present invention, a spacecraft (for example, transport ship) launched from the earth is monitored by a monitoring spacecraft disposed at a Lagrange point and a plurality of artificial satellites disposed on an orbit around a celestial body other than the earth. By this configuration, it is possible to observe the navigation of the spacecraft.

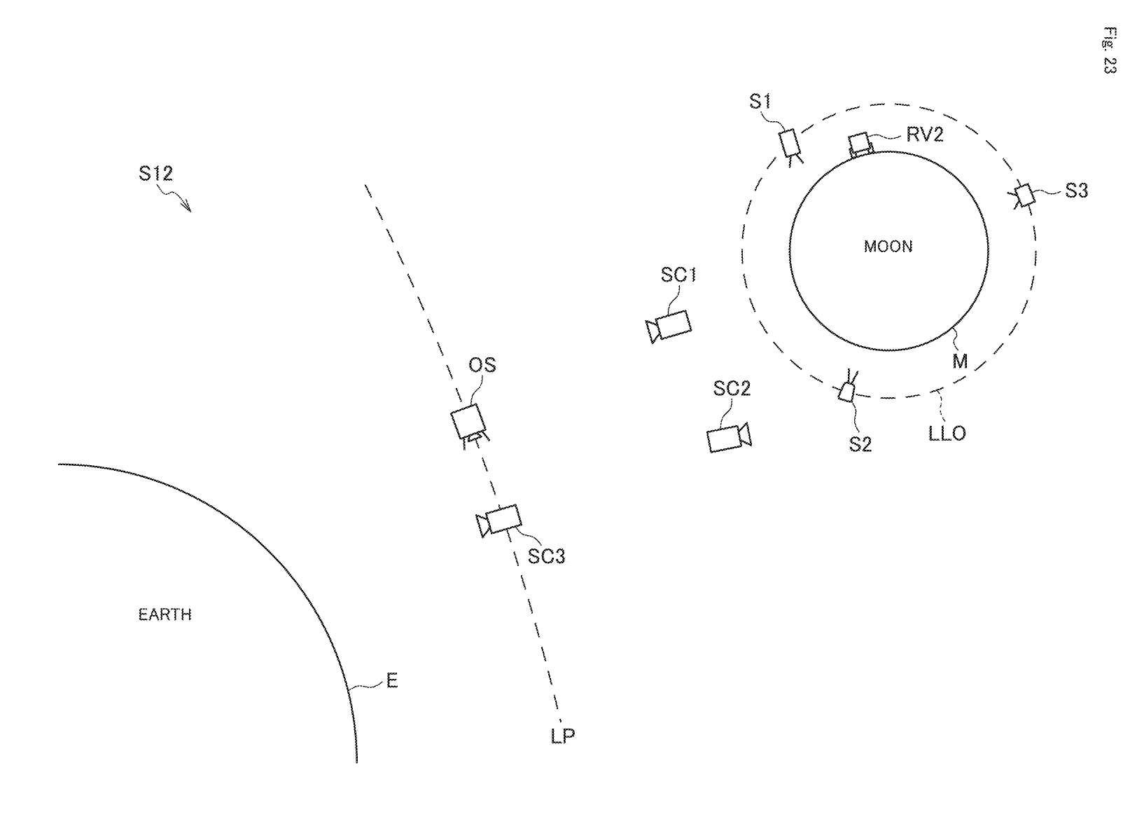

FIG. 23 is a schematic diagram for describing a monitoring method according to the twelfth embodiment. A monitoring system S12 according to the twelfth embodiment includes a monitoring spacecraft OS disposed at the Lagrange point LP, and artificial satellites S1, S2, and S3 disposed in a low lunar orbit (LLO). The monitoring spacecraft OS can stay at the Lagrange point LP because the Lagrange point LP is a position where the gravity of the earth and the gravity of the moon are balanced.

The monitoring spacecraft OS monitors spacecrafts SC1, SC2, and SC3 navigating from the earth E to the moon M. Here, the spacecrafts SC1, SC2, and SC3 are, for example, transport ships which transport space probes or artificial satellites. For example, the monitoring spacecraft OS observes the time when the spacecrafts SC1, SC2, and SC3 pass through the Lagrange point LP.

When arriving at the low lunar orbit (LLO) , the spacecrafts SC1, SC2, and SC3 may also eject one or a plurality of artificial satellites.

The artificial satellites S1, S2, and S3 function as global positioning system (GPS) satellites. The space probe RV2 disposed on the lunar surface may wirelessly receive signals from the artificial satellites S1, S2 and S3 to specify its own position on the lunar surface on the same principle as the GPS on the earth.

For example, the artificial satellites S1 and S2 and the monitoring spacecraft OS may transmit signals to the spacecraft SC1, SC2, and SC3, respectively. The spacecrafts SC1, SC2, and SC3 may wirelessly receive signals from the artificial satellites S1 and S2 and the monitoring spacecraft OS to specify its own position in outer space on the same principle as the GPS on the earth.

The twelfth embodiment describes that the number of artificial satellites is three as an example, but the number of artificial satellites may be four or more.

### Thirteenth Embodiment

Next, a thirteenth embodiment will be described. A lander according to the thirteenth embodiment includes a first interface which freely attaches and removes a propulsion system, in which a propulsion system (for example, a thruster, an engine, or the like) having a second interface suitable for the first interface can be replaced on celestial bodies (for example, planets, secondary planets, asteroids, or comets) other than the earth, and a standard of the first interface and the second interface is set. By this configuration, it is possible to easily replace the propulsion system by standardizing the first interface and the second interface.

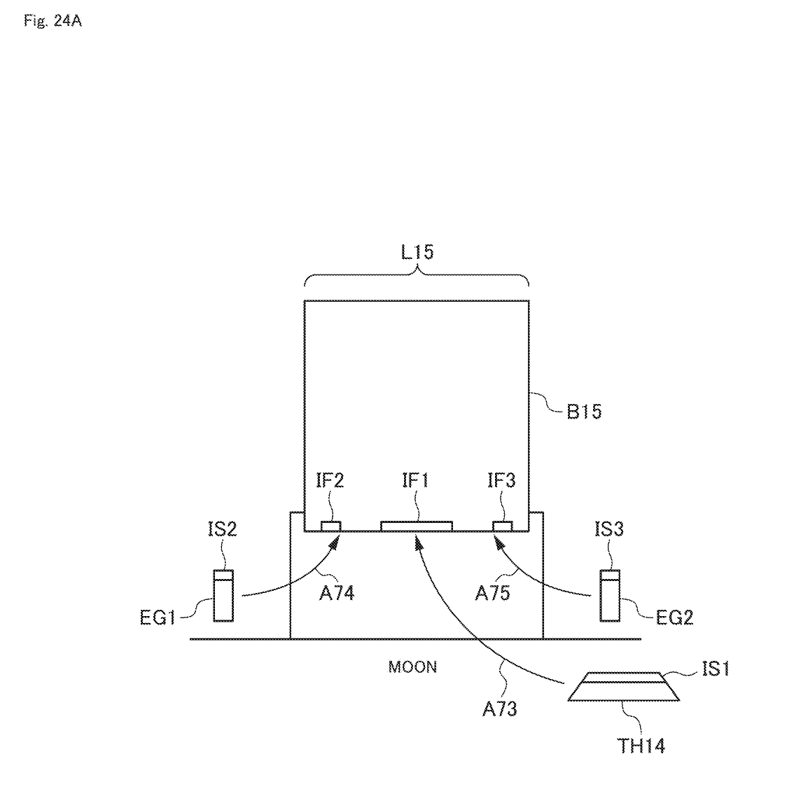

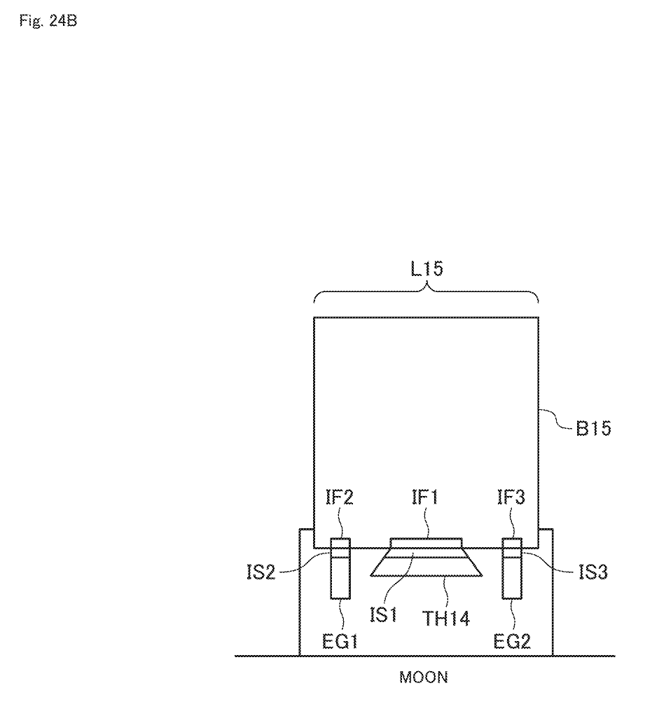

FIG. 24A is a schematic view showing a lander that is not equipped with the engine and the thruster in the thirteenth embodiment. FIG. 24B is a schematic view showing the lander that is equipped with the engine and the thruster in the thirteenth embodiment.

As shown in FIG. 24A, a lander LP15 is provided with an interface IF1 which freely attaches and removes a thruster and interfaces IF2 and IF3 which freely attaches and removes an engine.

A thruster TH4 has an interface IS1 suitable for the interface IF1.

An engine EG1 has an interface IS2 suitable for the interface IF2.

An engine EG2 has an interface IS3 suitable for the interface IF3.

As shown in FIG. 24B, the thruster TH4 is connected to a lander L15 by connecting between the interface IF1 and the interface IS1. In addition, the engine EG1 is connected to the lander L15 by connecting between the interface IF2 and the interface IS2. Similarly, the engine EG2 is connected to the lander L15 by connecting between the interface IF3 and the interface IS3.

### Fourteenth Embodiment

Next, a fourteenth embodiment will be described. A fuel supply method according to the fourteenth embodiment is a fuel supply method for allowing a transport ship in flight to supply fuel to another spacecraft, and includes a step of removing a first fuel tank from the spacecraft, and a step of removing a second fuel tank loaded on the transport ship, and a step of connecting the removed second fuel tank to the spacecraft. By this configuration, since the first fuel tank of the spacecraft can be replaced with the second fuel tank, it is possible to supply fuel to the spacecraft.

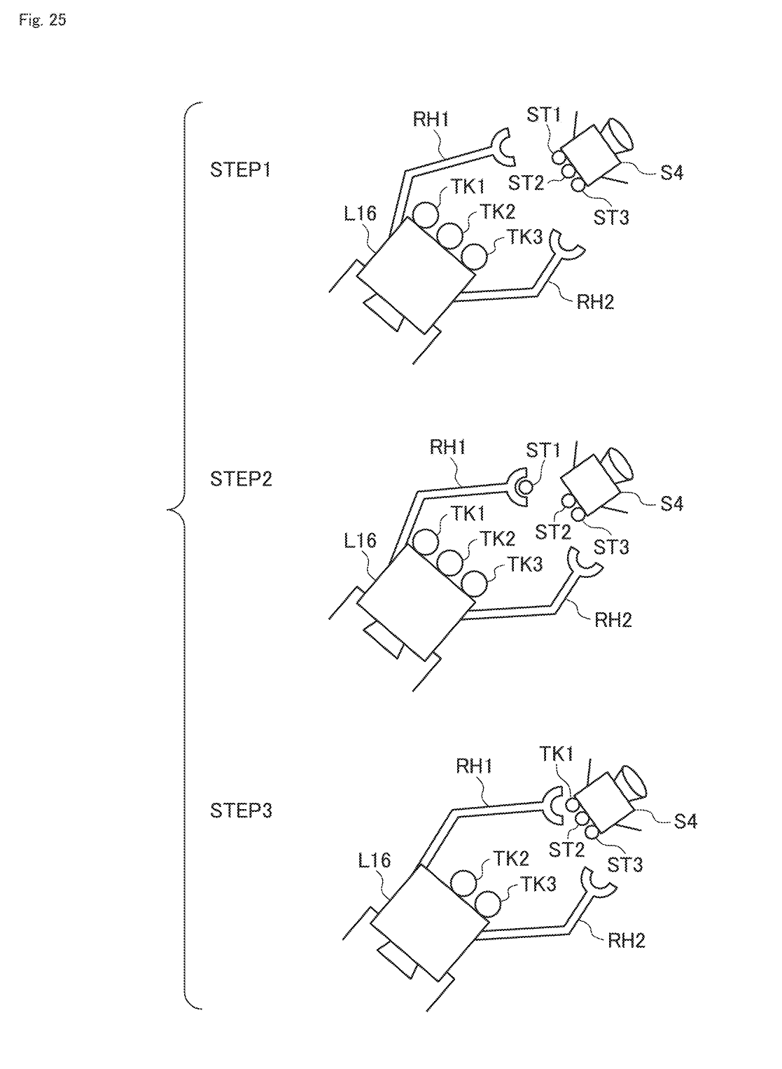

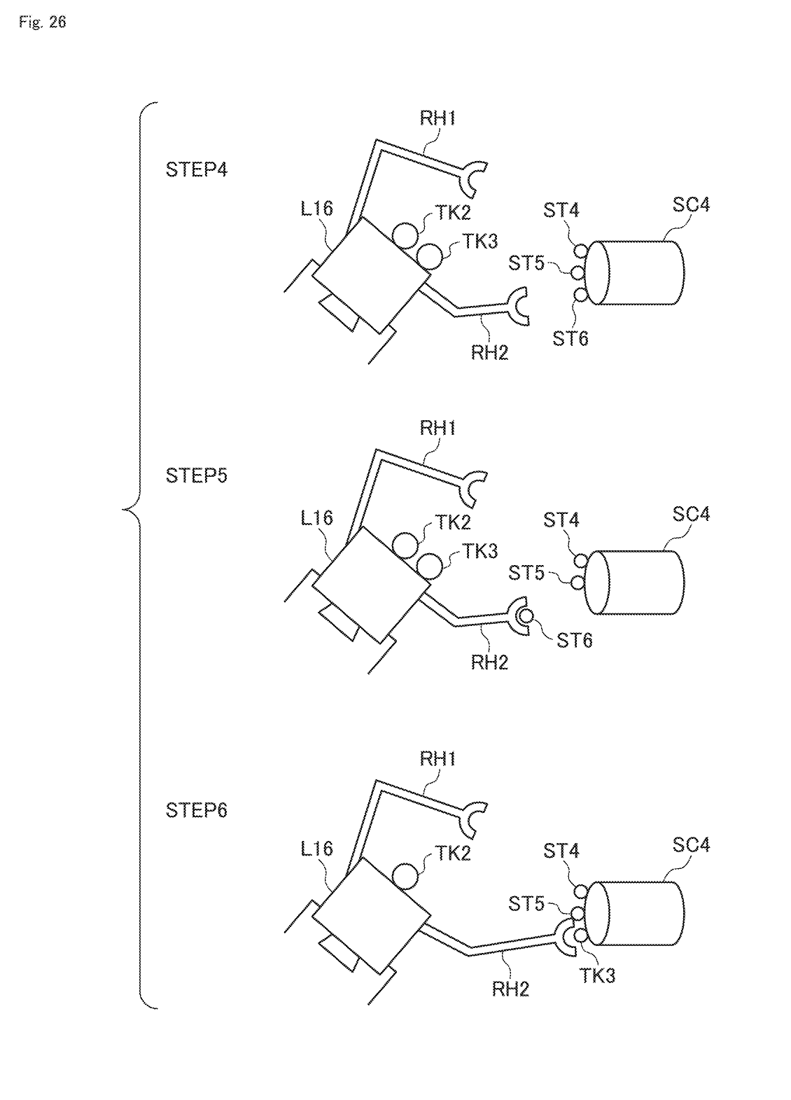

FIG. 25 is a schematic diagram showing a first half of steps of the fuel supply method according to the fourteenth embodiment. FIG. 26 is a schematic diagram showing a second half of the steps of the fuel supply method according to the fourteenth embodiment.

As shown in step 1 of FIG. 25, a lander L16 includes fuel tanks TK1, TK2, and TK3 and robot hands RH1 and RH2. On the other hand, an artificial satellite S4 which is an example of a spacecraft includes fuel tanks ST1, ST2, and ST3.

(Step 1) In FIG. 25, first, the lander L16 approaches the artificial satellite S4.

(Step 2) Next, the lander L16 uses the robot hand RH1 to remove the fuel tank ST1 without fuel from the artificial satellite S4. The removed fuel tank ST1 may be recovered by the lander L16 or may be dumped into outer space.

(Step 3) Next, the lander L16 uses the robot hand RH1 to remove its own fuel tank TK1 and attach the fuel tank TK1 to the artificial satellite S4. By doing so, the fuel tank ST1 without fuel can be replaced with the fuel tank TK1 of the lander L16, so fuel can be supplied to the artificial satellite S4.

(Step 4) Next, in FIG. 26, the lander L16 approaches the spacecraft SC4.

(Step 5) Next, the lander L16 uses the robot hand RH2 to remove a fuel tank ST6 without fuel from the spacecraft SC4. The removed fuel tank ST6 may be recovered by the lander L16 or may be dumped into outer space.

(Step 6) Next, the lander L16 uses the robot hand RH2 to remove its own fuel tank TK3 and attach the fuel tank TK3 to the spacecraft SC4. By doing so, the fuel tank ST6 without fuel can be replaced with the fuel tank TK3 of the lander L16, so fuel can be supplied to the spacecraft SC4.

### Fifteenth Embodiment

Next, a fifteenth embodiment will be described. A lander according to the fifteenth embodiment includes a housing, a switching mechanism which switches between an open state in which heat in the housing is discharged and a blocking state in which the heat in the housing is blocked, a temperature sensor which measures temperature outside the housing, and a processor, in which the processor controls the switching mechanism to switch between the open state and the blocking state according to the temperature measured by the temperature sensor. By this configuration, when the temperature outside the housing is increased, the switching to the blocking state is performed to suppress an inflow of heat into the housing, and when the temperature outside the housing is reduced, the switching to the open state is performed to discharge the heat into the housing, so it is possible to suppress the change in the temperature inside the housing.

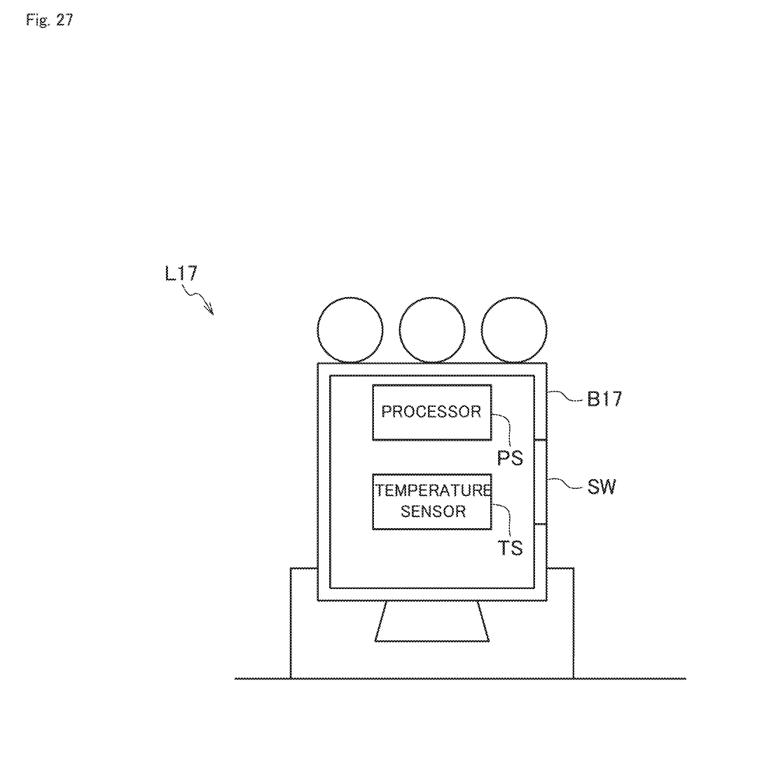

FIG. 27 is a schematic configuration diagram showing the lander according to the fifteenth embodiment. As shown in FIG. 27, a lander L17 includes a housing B17, a processor PS, a temperature sensor TS, and a switching mechanism SW.

The temperature sensor TS measures the temperature outside or inside the housing B17.

The switching mechanism SW switches between the open state in which the heat in the housing B17 is discharged and the blocking state in which the heat in the housing B17 is blocked.

The processor PS controls the switching mechanism SW to switch between the open state and the blocking state according to the temperature measured by the temperature sensor TS.

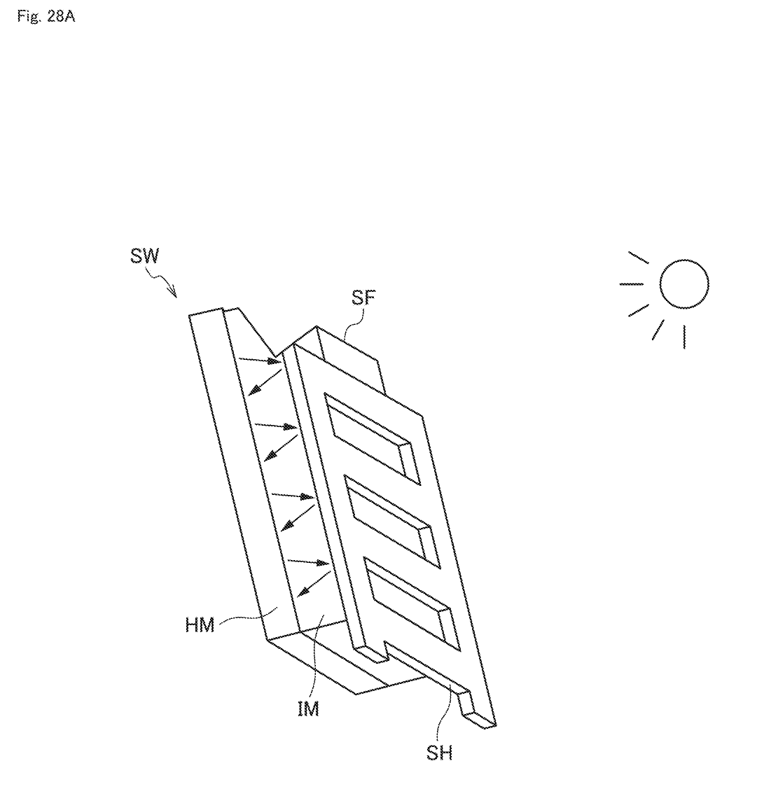

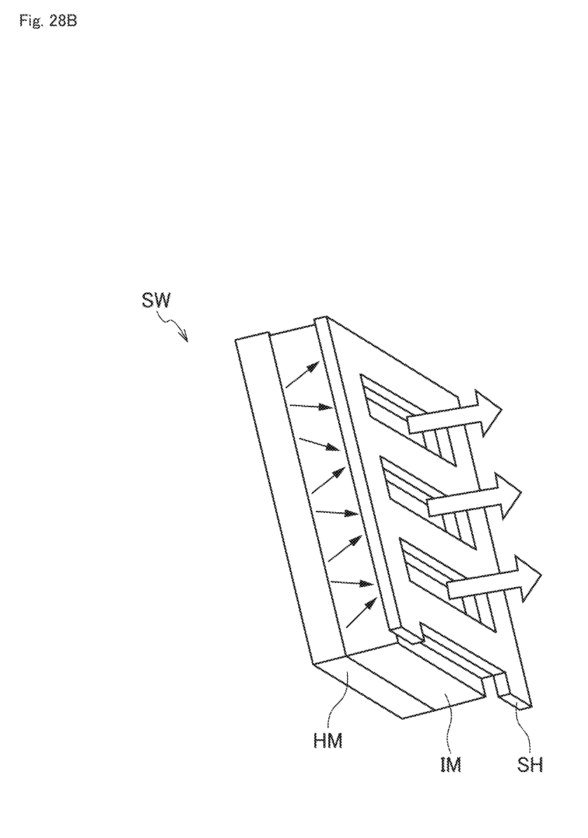

FIG. 28A is a schematic perspective view showing an example of the switching mechanism SW in the blocking state. FIG. 28B is a schematic perspective view showing an example of the switching mechanism SW in the open state.

As shown in FIG. 28A, the switching mechanism SW includes a first frame HM, a second frame IM stacked on the first frame, a shutter frame SF provided on the second frame IM, and a shutter SH which can slide in a longitudinal direction with respect to the shutter frame SF.

The shutter SH is provided with a plurality of first rectangular through-holes which are formed at intervals. Similarly, the shutter frame SF is also provided with a plurality of second rectangular through-holes which are formed at intervals. The second through-hole has, for example, substantially the same size as the first through-hole.

When the switching mechanism SW is in the blocking state, as shown in FIG. 28A, a main body portion (portion where the second through-hole is not open) of the shutter frame SF is disposed under a first through-hole of the shutter SH. Thereby, when the sun hits the lander L17, heat from the outside is blocked by the main body portion of the shutter frame SF, so that a heat insulating effect can be obtained and the temperature rise inside the housing B17 can be suppressed. Here, the shutter frame SF is preferably made of a highly heat insulating material. Thereby, the heat insulation effect can be improved when the switching mechanism SW is in the blocking state. In addition, as shown by the arrows in FIG. 28A, an internal gas is blocked by a back surface of the main body portion (portion where the first through-hole is not open) of the shutter SH and does not escape to the outside.

On the other hand, when the switching mechanism SW is in the open state, as shown in FIG. 28B, the second through-hole of the shutter frame SF is disposed under the first through-hole of the shutter SH. Thereby, the heat in the housing B17 is discharged to the outside of the housing B17 through the first through-hole of the shutter SH and the second through-hole of the shutter frame SF.

When the temperature outside the housing B17 is increased, as shown in FIG. 28A, the processor PS may perform control to switch to the blocking state. As a result, the inflow of the heat into the housing B17 can be suppressed. On the other hand, when the temperature outside the housing B17 is lowered, as shown in FIG. 28B, the processor PS may control the switching mechanism SW so as to switch to the open state. As a result, as shown by the arrows in FIG. 28B, when the heat in the housing B17 can be discharged. By doing so, the shutter SH is closed when it is hot due to the presence of sunlight or the like and the shutter SH is opened when it is cold due to the absence of sunlight, or the like, so it is possible to suppress a change in the temperature inside the housing B17.

It is to be noted that the temperature sensor TS measures the temperature inside the housing B17. As a result, the processor PS can control the switching mechanism SW so as to switch between the open state and the blocking state according to the temperature inside the housing B17.

In addition, the processor PS may control the switching mechanism SW so as to switch between the open state and the blocking state according to the preset period of the moon. For example, even if the processor PS controls the switching mechanism SW so as to switch to the blocking state during a period when sunlight hits the moon, and controls the switching mechanism SW so as to switch to the open state during a period when sunlight does not hit the moon.

In addition, the housing of the lander according to each embodiment may include graphene or graphene fiber as a material. A part of the material of the housing may be used, or the whole of the material may be used. Thereby, it is possible to improve the heat insulating property of the housing.

Hereinabove, the present disclosure can be embodied by modifying constituent elements within the range without departing from the gist thereof in implementation stages, without being limited to the above embodiments as they are. In addition, various inventions can be formed by appropriately combining a plurality of constituent elements disclosed in the above embodiment. For example, some constituent elements may be deleted from all the constituent elements shown in the embodiment. In addition, the constituent elements of different embodiments may be appropriately combined.

### REFERENCE SIGNS LIST

1, 2, 3 Transport ship
10 First module
11, 21, 31, 41 Tank
12, 22, 32, 42 Valve
13 Battery
14 Electric propulsion device
15, 16 Solar panel
20 Third module
30 Second module
33, 43, 51 Control unit
34, 44 Chemical propulsion device
35 Landing gear
40 Fourth module
50 Fifth module
AAA Avionics air assembly
AS Asteroid
B1, B2, B10, B17 Housing
CD, CON Controller
CM Comet
DCU DC Converter unit
DI Drawer interface panel
DM Drive mechanism
DR1 to DR4 Drawer
E Earth
HBU Hub unit
IF2, IF3 Interface
LC Launcher
LI1 to LI3 Lander interface panel
LS Lunar surface
M Moon
OS Monitoring spacecraft
P1 to P3 Panel
PD Heat insulating structure
PL4 Payload
PR1, PR2 3D printer
PS Processor
RF Reflector
RH1, RH2 Robot hand
RV1, RV2, RV11 to RV13 Space probe
S1 Satellite
SC1 to SC5 Spacecraft
SF Shutter frame
SN Sun
SP1, SP2, SP6 to SP8 Solar panel
SP1, SP2 Solar panel
ST1 to ST3 Fuel tank
TD1 Voltage input terminal
TD2 Signal input terminal
TE1 Voltage output terminal
TE2 Signal output terminal
TF Interface plate
TF2 Signal input terminal
TH, TH1, TH3, TH4 Thruster
TK, TK1 to TK4 Fuel tank
TL1 Voltage output terminal
TL2 Signal terminal
TS Temperature sensor
TT Heat insulating sheet
VCRU Video compression recording unit
VIU Vibration isolation unit
WC1, WC2 Communication unit
WV Housing

1-14. (canceled)

15. A lander, comprising:
a lander interface panel which connects between the lander and a drawer interface panel of a drawer in which a payload is mounted,
wherein the lander interface panel includes
a voltage output terminal connected to the drawer interface panel to supply a voltage to the payload via the drawer interface panel, and
a signal terminal connected to the drawer interface panel to exchange a signal with a controller mounted on the drawer via the drawer interface panel.

16. The lander according to claim 15, comprising:
a solar panel;
a drive mechanism which changes an inclination of the solar panel with respect to a horizontal plane; and
a controller which controls the drive mechanism to change the inclination of the solar panel with respect to the horizontal plane according to time, a position of the sun, or a power generation amount of the solar panel.

17. The lander according to claim 15, comprising:
a heat insulating sheet which is folded and stored and can be self-supported when being unfolded from the folded state,
wherein the heat insulating sheet is configured to cover an outside of the lander when being unfolded.

18. The lander according to claim 15, comprising:
a housing made of graphene or a graphene fiber as a material.

19. (canceled)

20. A method for manufacturing a component of a lander according to claim 15, comprising:
a step of manufacturing the component of the lander by a 3D printer disposed on a celestial body other than the earth.

21. The method for manufacturing a component of a lander according to claim 20, comprising:
a step of melting a broken or damaged component of the lander; and
manufacturing a component of a spacecraft by the 3D printer using the melted material as a raw material in the manufacturing step.

22. The method for manufacturing a component of a lander according to claim 20, comprising:
a step of extracting a natural resource on the celestial body other than the earth; and
manufacturing the component of the lander by the 3D printer using the extracted natural resource as the raw material in the manufacturing step.

23. A method for manufacturing a lander according to claim 15 on a celestial body other than the earth, comprising:
a step of extracting a natural resource on a celestial body other than the earth or melting a broken or damaged component of a lander;
a step of manufacturing a component of the lander by a 3D printer using the extracted natural resource or the melted material as a raw material; and
a step of attaching the manufactured component of the lander to a targeted lander.

24. The lander according to claim 15, comprising:
a movable leg or a wheel so as to be movable on a celestial body other than the earth.

25. The lander according to claim 15, comprising:
a reflector which reflects light,
wherein a direction of the reflector is set so that a solar panel of an object is irradiated with sunlight reflected from the reflector.

26. A method for landing a lander according to claim 15 on a targeted celestial body other than the earth, comprising:
a step of wirelessly transmitting a response request to any spacecraft existing on the targeted celestial body other than the earth;
a step of receiving a response signal including a position of a self-controlled spacecraft which is transmitted in response to the response request; and
a step of landing the lander while avoiding a position included in the response signal.

27. A method for landing a lander according to claim 15 on a celestial body other than the earth, comprising:
a step of acquiring map data of a celestial body scheduled to land from an artificial satellite by wireless communication;
a step of determining whether or not a zone scheduled to land is an unstable zone by using the map data; and
a step of igniting a thruster of the lander to land the lander on different zones if it is determined that the landing zone is the unstable zone.

28. (canceled)

29. The lander according to claim 15, comprising:
a first interface which freely attaches and removes a propulsion system,
wherein the propulsion system having a second interface suitable for the first interface can be replaced on a celestial body other than the earth, and
a standard of the first interface and the second interface is set.

30. (canceled)

31. The lander according to claim 15, comprising:
a housing;
a switching mechanism which switches between an open state in which heat in the housing is discharged and a blocking state in which the heat in the housing is blocked;
a temperature sensor which measures temperature inside or outside the housing; and
a processor which controls the switching mechanism to switch between the open state and the blocking state according to the temperature measured by the temperature sensor.

32. A transport method, comprising:
a first step of propelling a transport ship from a low earth orbit or a geostationary transfer orbit to a targeted orbit or a destination by electric propulsion;
after the first step, a second step of propelling the transport ship by chemical propulsion; a step of separating a module having an electric propulsion device from the transport ship between the first step and the second step; and
after the separating step and before the second step, a step of controlling an attitude of the transport ship so that a direction in which a chemical propulsion device ejects a gas is directed in a direction opposite to a traveling direction of the transport ship,
wherein the first step includes a step of expanding a solar panel on which a solar cell is mounted, the second step includes a step of propelling the transport ship from a lunar transfer orbit to a low lunar orbit, separating a module having a tank for the chemical propulsion after the propulsion to the low lunar orbit, and landing the transport ship on a lunar surface after the separation,
the electric propulsion is made by using power generated by a solar cell.

33. The transport method according to claim 32, comprising a step of propelling the transport ship from the lunar transfer orbit to a low lunar orbit and separating cargo after the propulsion to the low lunar orbit in the second step.

34. The transport ship comprising:
a first module having a electric propulsion device which propels a transport ship from a low earth orbit or a geostationary transfer orbit to a targeted orbit or a destination by electric propulsion and a tank in which a propellant of the electric propulsion device is stored; and
a fourth module which has a chemical propulsion device and a control unit,
wherein the control unit controls the opening and closing of the valve of the tank of the first module.
